(19) United States
(12) Patent Application Publication
(10) Pub. No.: US 2005/0119934 A1
(43) Pub. Date: Jun. 2, 2005

(54) Advertisement proxy method and advertisement proxy mediating system

(76) Inventor: Futoshi Kamiyama, Itabashi-ku (JP)

Correspondence Address: Edward A Pennington;Swidler Berlin Shereff Friedman, Suite 300, 3000 K Street NW, Washington, DC, 20007-5116, US

(21) Appl. No.: 10/505,594

(22) PCT Filed: Feb. 26, 2002
(86) PCT No.: PCT/JP02/01739

(30) Foreign Application Priority Data
Feb. 26, 2001 (JP) 2001-49861
Feb. 21, 2002 (JP) 2002-044601

(51) Int. Cl. G06F 17/60

(52) U.S. Cl. 705/14

(57) ABSTRACT

An advertising media information mediating system is provided which uses a computer system for providing an advertising service substitution method and in which an advertisement requester can register advertisement request conditions on an advertising media information mediating server through a simple operation, whereas an advertising agent substitute, who executes an advertisement on behalf of the advertisement requester, can register advertising service substitution conditions on the advertising media information mediating server through a simple operation, whereby the advertisement requester and the advertising agent substitute can select an advertising transaction partner which can meet conditions desired by the advertisement requester and the advertising agent substitute from a variety of selection targets via a network without spending much time, the advertising service substitution method being such that the advertisement requester registers advertisement request conditions, whereas the advertising agent substitute registers advertising service substitution conditions, whereby when the advertisement requester and the advertising agent substitute come to an agreement based on the advertising service substitution conditions and the advertisement request conditions so registered, the advertisement requester pays part of or the whole of expenditures for an advertising material and advertisement using the same, whereas the advertising agent substitute executes an advertisement on behalf of the advertisement requester by wearing, using, displaying, selling, lending or distributing the advertising material.

### BACKGROUND OF THE INVENTION

1. Technical Field

The present invention relates to an advertising service substitution method for enabling the realization of an advertisement that is made by a substitute for an advertising agent or advertisement requester on behalf of the advertisement requester by wearing, using, displaying, selling, lending or distributing advertising materials and an advertising media information mediating system for enabling the realization of an advertisement by the advertising agent substitute on behalf of the advertisement requester by mediating between the advertisement requester and the advertising agent substitute who executes an advertisement on behalf of the advertisement requester by wearing, using, displaying, selling, lending or distributing advertising materials.

2. Background Art

It has been conventionally known that advertisements for products and services are made by using printed matters (magazines, newspapers, flyers, printed ads in railway carriages). In addition, it is also know that the information is stored in a storage medium (CD-ROM, floppy disk) for distribution to the market so as to advertise the products and services by displaying the information on computer system terminals or that the advertisement for the products and services are made by conveying the information to viewers and listeners through a one-way medium such as televisions and radios.

Furthermore, it is also know that females wear the closing on which advertising information for a product, service or corporation is illustrated to advertise the product, service or corporation during a product, service of corporation advertising campaign.

In these cases, however, the advertisement requester produces clothing, fixtures, panels, accessories, small articles which illustrates advertising information for the product, service or corporation only for the advertisement of the product, service or corporation, and furthermore, the specific females or the like wear the advertising clothing only for the specific product, service or corporation advertising campaign. In addition, the advertisement is carried out only by a limited number of advertising people during a limited period of time. Due to this, the advertisement requester can draw people's attention to the product, service or corporation for the limited period time, but it cannot be expected that the advertising effect is maintained among the advertising target people for a certain length of time.

### SUMMARY OF THE INVENTION

The present invention was made in view of the problem, and an object thereof is to enable the realization of an advertisement that is made by an advertising agent substitute on behalf of an advertisement requester by letting known to advertising agent substitutes advertisement request conditions which are requests from the advertisement requester on advertisement targets (products, information, visual images, addresses such as home page addresses and mailing addresses, services, names of individuals, names of corporations, names of groups or the like), and the number of people, period of time, place, date and time, advertisement posting space, targets on which advertisement is displayed which are constituent factors for realizing an advertisement by the advertising agent substitute on behalf of the advertisement requester by wearing, using, displaying, selling, lending or distributing advertising materials, and finding among the advertising agent substitutes an advertising agent substitute who can meet the advertisement request conditions so let known.

On the other hand, another object of the invention is to provide an advertising service substitution method for enabling the realization of an advertisement by an advertising agent substitute on behalf of an advertisement requester by wearing, using, displaying, selling, lending or distributing advertising materials which allows the advertising agent substitute to pay only part of expenditures for advertising materials without paying the whole expenditures therefor and furthermore to obtain earnings from the advertisement.

Furthermore, a further object of the invention is to provide an advertising media information mediating system in which an advertisement requester can register on a computer system through a simple operation advertisement request conditions which are the requests from the advertisement requester on advertisement targets (products, information, visual images, addresses such as home page addresses and mailing addresses, services, names of individuals, names of corporations, names of groups or the like), and the number of people, period of time, place, date and time, advertisement posting space, targets on which advertisement is displayed, and on the other hand, an advertising agent substitute can register on a computer system through a simple operation advertising service substitution conditions on advertisement targets (products, information, visual images, addresses such as home page addresses and mailing addresses, services, names of individuals, names of corporations, names of groups or the like), and the number of people, period of time, place, date and time, advertisement posting space, targets on which advertisement is displayed, which are conditions based on which the advertising agent substitute can make an advertisement on behalf of an advertisement requester, whereby the advertisement requester can select an advertising agent substitute who can meet the desired advertisement request conditions from a wide variety of advertising agent substitutes without spending much time via a network of computer systems.

In addition, an object of the invention is to provide an advertising service substitution method in which in the event that the advertising agent substitute wears a uniform, costume or sportswear in advertising a corporation, organized body, sports team (professional or amateur), university circle, individual or private group, expenditures that are borne by the advertising agent substitute can be reduced or costs can be saved by bearing only part of the expenditures and earnings can be obtained from the advertisement by wearing a uniform, costume or sportswear which carries thereon an advertising material for a specific advertisement made by the advertising agent substitute on behalf of the advertisement requester.

Then, in the event that what carries the advertising material is a stage costume, costs for the costume and for producing a stage can be reduced, and advertisement earnings can be obtained.

In addition, in the event that what carries the advertising material is a terraced balcony, table, chair, sofa, ceiling, roof, billboard, menu, receipt, pamphlet, pinball or pachinko game table, roulette (table), game machine, slot machine, game giveaway, window glass, fork, spoon, glass, plate, straw, shopping bag, paper bag, doorstep mat, door or the like, costs associated with the advertisement can be reduced and advertising earnings can be obtained.

Furthermore, another object of the invention is to provide an advertising media information mediating system in which in the event that the advertising agent substitute is a sports team, the advertising agent substitute registers on a computer system as information playing schedule, number of people who are expected to visit a playing place, whether or not a broadcast is scheduled over a TV network, whether or not interviews of players by magazines are planned, whether or not exposures via newspapers and/or posters are scheduled or the like, so that an advertisement requester can retrieve playing schedules of the advertising agent substitute who performs an advertisement on behalf of the advertisement requester using advertising materials through a simple operation, whereby the advertisement requester can place with the advertising agent substitute a request for performing an advertisement on behalf of the advertisement requester in consideration of the exposure schedules of the advertising materials.

A further object of the present invention is to provide an advertising media information mediating system in which in the event that the advertising agent substitute is a model, musician, artist, talent, public entertainer, famous person or the like, the advertising agent substitute registers on a computer system as information the number of people who are expected to visit a concert, talk show, event, stage, fashion show or the like, whether or not a broadcast is scheduled over a TV network, whether or not interviews of players by magazines are planned, whether or not exposures via newspapers and/or posters are scheduled or the like, so that an advertisement requester can retrieve playing schedules of the advertising agent substitute who performs an advertisement on behalf of the advertisement requester using advertising materials through a simple operation, whereby the advertisement requester can place with the advertising agent substitute a request for performing an advertisement on behalf of the advertisement requester in consideration of the exposure schedules of the advertising materials.

According to an aspect of the present invention, there is provided, with a view to attaining the objects, an advertising service substitution method in which an advertisement requester registers advertisement request conditions on an advertising media information mediating server, whereas an advertising agent substitute, who executes an advertisement on behalf of the advertisement requester, registers advertising service substitution conditions on the advertising media information mediating server, whereby when the advertisement requester and the advertising agent substitute retrieve the advertising service substitution conditions and the advertisement request conditions, respectively, via a network, and come to an agreement on the conditions, the advertisement requester pays part of or the whole of expenditures for advertising materials and advertisement, whereas the advertising agent substitute performs an advertisement by wearing, using, displaying, selling, lending or distributing the advertising materials.

Note that the advertising materials are those to which advertisement is added and include clothes, footwear, bag, ornament to be worn, woven fabric and other personal belongings.

The clothes include western-style clothes, Japanese-style clothes, uniform, national costume, business uniform, sports uniform, school uniform, stage costume, working clothes, pajamas, jersey, coat, stomach band, garter belt, bib, raincoat, livery coat, underwear, apron, scarf, necktie, bow tie, socks, gloves, hat or cap, swimming suit, T-shirt, jacket, blouson, shirt, blouse, slacks, pants, vest, overall, corset, underpants, brassier, trunks, bandanna, triangle bandage, and space suit.

The footwear includes shoes, leather-soled sandals, boots, sneakers, slippers and sandals. The bag includes a bag, waist bag, attache case, brief case and valise.

The ornament to be worn includes a liquid crystal display, plasma display, light-emitting diode and electronic paper which are designed to be worn, and furthermore, bracelet, wrist watch, necklace, brooch, and ring.

The woven fabric includes towel, table cloth, napkin, and handkerchief.

The other personal belongings include a helmet, umbrella, headband, bandanna, non-woven fabric, eye-glasses, sunglasses, mask, eye bandage, badge, button, emblem, tape, cloth, fabric, ribbon, name plate, sash used for holding up tucked sleeves, shoulder strap, arm strap, carrying strap and neck holder.

In addition, the advertising materials include a terraced balcony, table, chair, sofa, tatami mat, low tea or dining table, foot warmer, tile, ceiling, floor, wall, illuminating appliance, table cloth, table mat, napkin, roof, roof top, dinner paper, tray mat, toilet paper, banner, facade, billboard, coaster banner, flag or banner on a pole, rug, paper apron, menu, receipt, pamphlet, mirror, playing machine table (pinball or pachinko and slot machine table, pinball or pachinko table, roulette (table), game machine, game table, darts (table), pinball table, slot machine, vending photographing machine and game giveaway), window glass, playing card, chop stick, chop stick case, fork, spoon, straw, straw bag, shopping bag, paper bag, doorstep mat, door, card, map, PET bottle container (including a label thereon), glass, plate, bowl, and paper glass.

In addition, the application of advertisement on a thing means describing the contents of advertisement on the thing by means of a special film, seal, sticker, printing, stitching, labeling, printing, liquid crystal display, electronic paper, plasma display, light emitting diode, digital processing, transfer processing, dying, bleaching, carving, punching or the like.

Then, the contents of advertisement include information on names or titles of a corporation, organized body, team, individual, piece of composed music, visual image work, published material, program, advertising product (including vehicle such as automobile, motorcycle and bicycle, domestic electric appliance, drink, food, biscuit, chocolate, and sweets such as chewing gum), visual images, home page address or E-mail address, mailing address and telephone number of a corporation, organized body, team and individual.

In addition, the advertisement request conditions mean not only an advertisement through wearing, using, displaying, selling, lending or distributing but also wide promotion activities including posting posters, placing catalogues, displaying and sampling new products and performing events.

According to the aspect of the invention, since the advertisement requester can make a request for an advertisement which can provide a strong visual impact by the advertising agent substitute who moves while wearing and using the advertising materials under the desired advertisement request conditions and can apply the advertisement onto various advertising target materials, a larger advertising effect can be expected. On the other hand, the advertising agent substitute can reduce its business overhead costs in the event that the material to which the advertisement is applied is a business uniform, and the advertising agent substitute can also obtain earnings from the advertising activity.

According to another aspect of the present invention, there is provided an advertising media information mediating system, which is a computer system for mediating information on advertising media, comprising a function to encourage through a network an advertisement requester to input on a terminal thereof advertisement request conditions which are requests from the advertisement requester on advertising contents including advertisement targets (products, information, corporations, or organized bodies), and the number of people, period of time, place, date and time, advertisement posting space, targets on which advertisement is displayed which are constituent factors for realizing an advertisement by the advertising agent substitute on behalf of the advertisement requester by wearing, using, displaying, selling, lending or distributing advertising materials, a function to store the input information on a storage means, a function to encourage through the network an advertising agent substitute, who executes an advertisement on behalf of the advertisement requester using the advertising materials, to input on a terminal thereof advertising service substitution conditions on the number of people, period of time, place, date and time, advertisement posting space, targets on which advertisement is displayed which are constituent factors for realizing an advertisement by the advertising agent substitute on behalf of the advertisement requester by wearing, using, displaying, selling, lending or distributing advertising materials, a function to store the input information on a storage means, a function to output the advertising service substitution conditions stored in the storage means in response to an output request by the advertisement requester from the terminal thereof, and a function to output the advertisement request conditions stored in the storage means in response to an output request by the advertising agent substitute from the terminal thereof.

According to the aspect of the invention, the advertisement requester can register the desired advertisement request conditions on the computer system through a simple operation, whereas the advertising agent substitute can register the advertising service substitution conditions on the computer system through a simple operation, whereby the advertisement requester can obtain information on the registered advertising service substitution conditions through a simple operation, and the advertising agent substitute can obtain information on the registered advertisement request conditions through a simple operation.

In addition, according to the aspect of the invention, the advertisement requester and the advertising agent substitute can select an advertising business partner from a wide variety of advertisement requesters and advertising agent substitutes without spending much time.

According to a further aspect of the invention, there is provided an advertising media information mediating system comprising a retrieval function in which the advertisement requester can retrieve advertising service substitution conditions which match the desired conditions from advertising service substitution conditions which are stored in the storage means.

According to the aspect of the invention, the advertisement requester can obtain information on the desired advertising service substitution conditions efficiently through the simple operation.

Furthermore, according to an aspect of the invention, there is provided an advertising media information mediating system comprising a function in which the advertising agent substitute can retrieve advertisement request conditions which match the desired conditions from advertisement request conditions which are stored in the storage means.

According to the aspect of the invention, the advertising agent substitute can obtain information on the desired advertisement request conditions efficiently through the simple operation.

In addition, according to another aspect of the invention, there is provided an advertising media information mediating system comprising a function in which an advertisement requester can negotiate or proceed with a required transaction for agreement via the advertising media information mediating system with an advertising agent substitute who has inputted advertising service substitution conditions which match conditions desired by the advertisement requester.

According to the aspect of the invention, the advertisement requester can negotiate or proceed with a required transaction for agreement with the advertising agent substitute who has inputted the advertising service substitution conditions which match the conditions desired by the advertisement requester through a simple operation without spending much time, thereby making it possible for both the parties to proceed with the required transactions quickly and smoothly.

Furthermore, according to a further aspect of the invention, there is provided an advertising media information mediating system comprising a function in which an advertising agent substitute can negotiate or proceed with a required transaction for agreement via the advertising media information mediating system with an advertisement requester who has inputted advertisement request conditions which match conditions desired by the advertising agent substitute.

According to the aspect of the invention, the advertising agent substitute can negotiate or proceed with a required transaction for agreement with the advertisement requester who has inputted the advertisement request conditions which match the conditions desired by the advertising agent substitute through a simple operation without spending much time, thereby making it possible for both the parties to proceed with the required transactions quickly and smoothly.

In addition, according to an aspect of the invention, there is provided an advertising media information mediating system comprising a function to encourage an advertisement requester, an advertising agent substitute and an advertisement mediator to input respective identification IDs and passwords and a function to determine whether or not an input or output of information is permitted based on the identification IDs and passwords so inputted.

According to the aspect of the invention, since the input and output of information by other people than the advertisement requester, advertising agent substitute and advertisement mediator can be restricted, the safety and reliability of the system can be maintained high.

Furthermore, according to another aspect of the invention, there is provided an advertising media information mediating system in which an advertisement requester registers contents of advertisement such as advertising targets (products, information, corporations, organized bodies) and the number of people, period of time, targets, areas, and advertising budget for an advertisement which the advertisement requester wants to be made by an advertising agent substitute using advertising materials, whereas an advertising agent substitute registers, who executes an advertisement on behalf of an advertisement requester, registers the number of people, period of time, place, date and time, advertisement posting space and target materials to which advertisement can be applied which are conditions for making an advertisement on behalf of an advertisement requester by wearing, using, displaying, selling, lending or distributing advertising materials, whereby in the event that the advertisement requester and the advertising agent substitute agree on the advertisement request conditions and the advertising service substitution conditions, the advertisement requester pays part of or the whole of expenditures for advertising materials and making the agreed advertisement, whereas the advertising agent substitute makes the agreed advertisement by wearing, using, displaying, selling, lending or distributing the advertising materials.

Note that the advertisement requester is an advertising agent or a person who wants to produce an advertisement for its product information, service and itself and includes an individual, corporation, shop, organized body and university. On the other hand, the advertising agent substitute is a person who wears, uses, displays, sells, lends or distributes advertising materials and includes a n individual, corporation, shop, organized body and university.

Furthermore, the advertisement by means of the advertising materials is an activity which, in the event that the advertisement requester is a drinks maker and the advertising agent substitute is a filling station, provides an advertising effect on customers who come to the filling station for refilling their vehicles or those who pass by the vicinity of the filling station by making its employees wear a uniform illustrating thereon a photograph of an drink which is an advertising product of the drinks maker, a character used for advertisement of the product, and/or characters describing the product.

According to the aspect of the invention, since the advertisement requester can cause the advertising materials which can provide a strong visual impact when a person moves while wearing or using the same to be worn, used, displayed, sold, lent or distributed, a larger advertising effect can be expected. On the other hand, in the event that the clothes to which the advertisement is applied are a business uniform, the advertising agent substitute can reduce the overhead costs involved in the business and obtain earnings from the advertisement.

In addition, in the event that what carries the advertisement is a stage costume, the advertising agent substitute can save expenditures for costumes and for producing a stage and obtain earnings from the advertisement.

In addition, in the event that what carries the advertisement is a sport team, the sport team who acts as an advertising agent substitute can reduce expenditures for uniforms and sports things and obtain earnings from the advertisement.

In addition, in the event that what carries the advertisement is part or the whole of a shop or facility, the owner of the shop or facility can reduce the expenditures therefor and can get earnings form the advertisement.

Furthermore, according to the invention, the advertising mediator is provided with a server, and a system is provided on the server for mediating advertising media information via the network.

In the system, the advertisement requester is provided with a function to permit the advertisement requester to use the system by inputting an identification ID and a password which the advertisement requester is given after a predetermined agreement is made with the advertising mediator, a function to encourage the advertisement requester to input advertisement request conditions on a terminal thereof, a function to store the input information on a storage means, a function to output the advertising service substitution conditions which are stored on the storage means in response to an output request from the advertisement requester, a function to permit the advertisement requester to retrieve advertising service substitution conditions which match conditions desired by the advertisement requester from advertising service substitution conditions which are stored on the storage means and a function to permit the advertisement requester to negotiate or proceed with a required transaction for agreement via the system with an advertising agent substitute who inputs advertising service substitution conditions which match the desired conditions of the advertisement requester.

On the other hand, the advertising agent substitute, who executes an advertisement on behalf of the advertisement requester by wearing, using, displaying, selling, lending or distributing the advertising materials, is provided with a function to permit the advertising agent substitute to use the system by inputting an identification ID and a password which the advertising agent substitute is given after a predetermined agreement is made with the advertising mediator, a function to encourage the advertising agent substitute to input advertising service substitution conditions on a terminal thereof, a function to store the input information on a storage means, a function to output the advertisement request conditions which are stored on the storage means in response to an output request from the advertising agent substitute, a function to permit the advertising agent substitute to retrieve advertisement request conditions which match conditions desired by the advertising agent substitute from advertisement request conditions which are stored on the storage means and a function to permit the advertising agent substitute to negotiate or proceed with a required transaction for agreement via the system with an advertisement requester who inputs advertisement request conditions which match the desired conditions of the advertising agent substitute.

In addition, the advertising mediator is provided with a function to permit the advertising mediator to use the system by inputting an identification ID-and a password, a function to permit the advertising mediator to perform the same operations as those performed by the advertisement requester and the advertising agent substitute and a function to permit the advertising mediator to mediate a negotiation or transaction for agreement between the advertisement requester and the advertising agent substitute.

Note that the advertisement requester includes an advertising agent who receives a request for advertisement from a person who wants to advertise its product, service, corporation, organized body or the like.

Note that the advertising agent substitute includes causing not only human beings but also animals, insects, reptiles, birds, butterflies, apes which are kept by the human beings to wear and use the advertising materials or applying the advertising materials to those, or displaying and selling the advertising product by wearing, using or applying the advertising materials to those.

### BRIEF DESCRIPTION OF THE DRAWINGS

FIG. 1 is a block diagram illustrating the configuration of a first embodiment according to the invention,

FIG. 2 is a block diagram illustrating the configuration of an advertising media information mediating server according to the same embodiment,

FIG. 3 is a flow diagram illustrating an operation performed by an advertisement requester according to the first embodiment,

FIG. 4 is a flow diagram illustrating part of the operation performed by the advertisement requester according to the same embodiment,

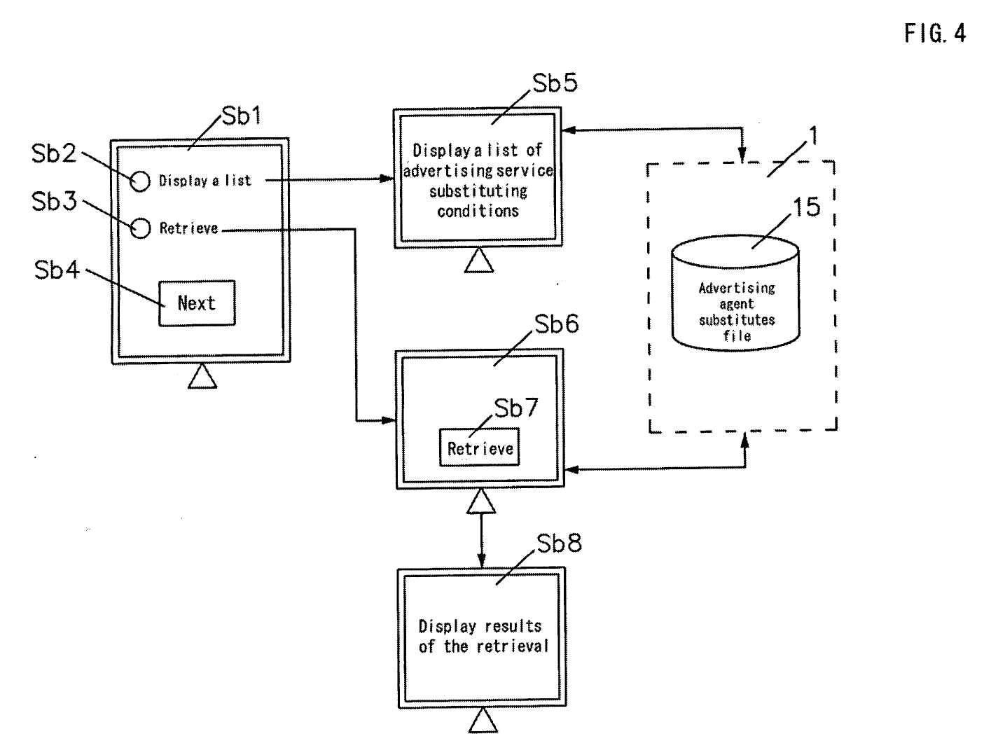

FIG. 5 is a drawing showing part of a screen showing an advertisement requester menu according to the first embodiment,

FIG. 6 is a drawing showing part of a screen showing an advertisement requester menu according to the same embodiment,

FIG. 7 is a drawing showing part of a screen showing an advertisement requester menu according to the first embodiment,

FIG. 8 is a drawing showing part of a screen showing an advertisement requester menu according to the same embodiment,

FIG. 9 is a drawing showing part of a screen showing an advertisement requester menu according to the first embodiment,

FIG. 10 is a drawing showing part of a screen showing an advertisement requester menu according to the same embodiment,

FIG. 11 is a flow diagram illustrating an operation performed by an advertising agent substitute according to the first embodiment,

FIG. 12 is a flow diagram illustrating part of the operation performed by the advertising agent substitute according to the same embodiment,

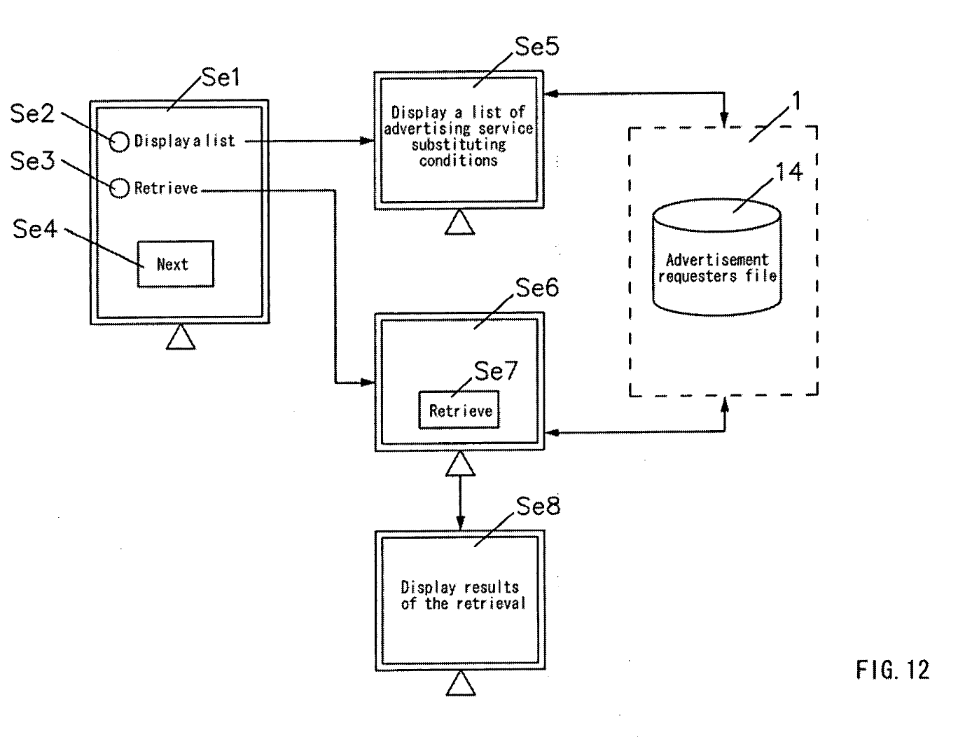

FIG. 13 is a drawing showing part of a screen showing an advertising agent substitute menu according to the first embodiment,

FIG. 14 is a drawing showing part of a screen showing an advertising agent substitute menu according to the same embodiment,

FIG. 15 is a drawing showing part of a screen showing an advertising agent substitute menu according to the first embodiment,

FIG. 16 is a drawing showing part of a screen showing an advertising agent substitute menu according to the same embodiment,

FIG. 17 is a drawing showing part of a screen showing an advertising agent substitute menu according to the first embodiment,

FIG. 18 is a drawing showing part of a screen showing an advertising agent substitute menu according to the first embodiment,

FIG. 19 is a drawing illustrating an operation performed by an advertising mediator according to the first embodiment,

FIG. 20 is a drawing illustrating part of the operation performed by the advertising mediator according to the same embodiment,

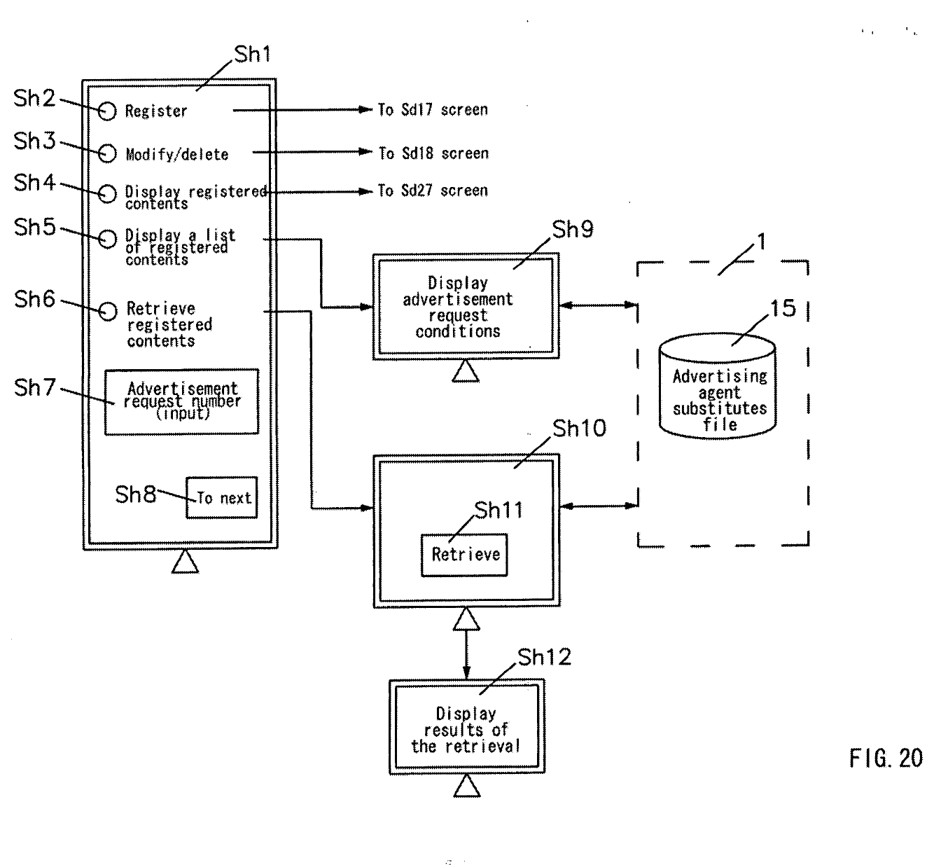

FIG. 21 is a drawing showing part of a screen showing an advertising mediator menu according to the first embodiment,

FIG. 22 is a drawing showing part of a screen showing an advertising mediator menu according to the first embodiment, and

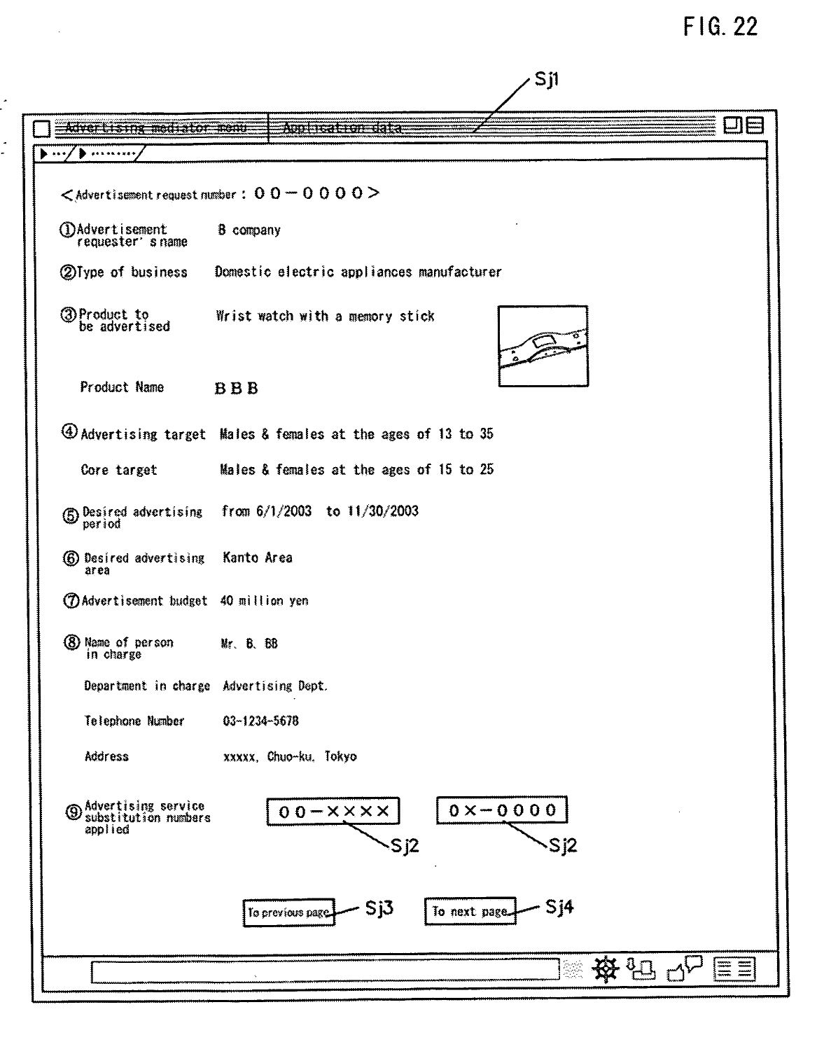

FIG. 23 is a drawing showing a media schedules management table according to the first embodiment.

### DESCRIPTION OF THE PREFERRED EMBODIMENT

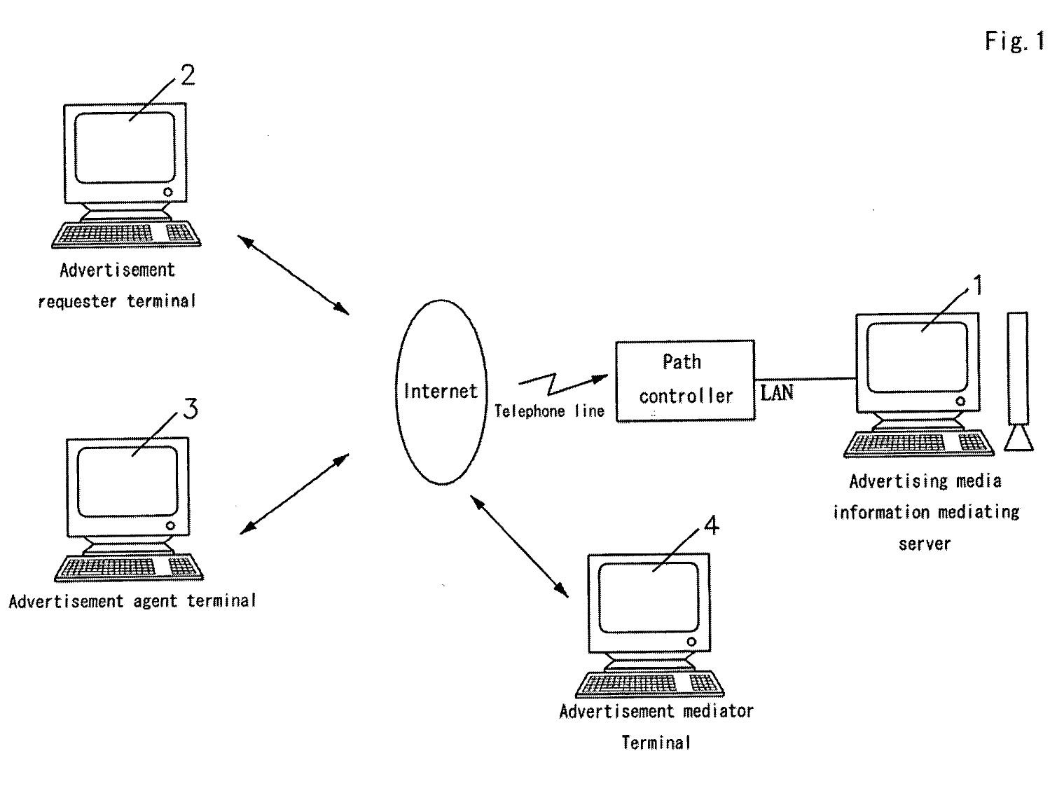

An embodiment of the present invention will be described below based on the accompanying drawings. FIG. 1 is a block diagram illustrating the configuration of the embodiment. In the drawing, reference numeral 1 denotes a server, which is connected to an internet via a path controller and a telephone line. Reference numeral 2 denotes a terminal for an advertisement requestor, reference numeral 3 denotes a terminal for an advertising agent substitute and reference numeral 4 denotes a terminal for an advertising mediator, the terminals being connected to the internet in a similar manner in which the server is connected thereto. Here, the terminals 2, 3, 4 each have a display unit such as a CRT or LCD and an input unit such as a keyboard and a mouse. In addition, while, normally, there exist polarities of advertisement requesters and advertising agent substitutes and there also exist pluralities of advertisement requester terminals and advertising agent substitute terminals, only a single advertisement requester terminal and a single advertising agent substitute terminal are shown as representing the pluralities of terminals as a matter of conveniences.

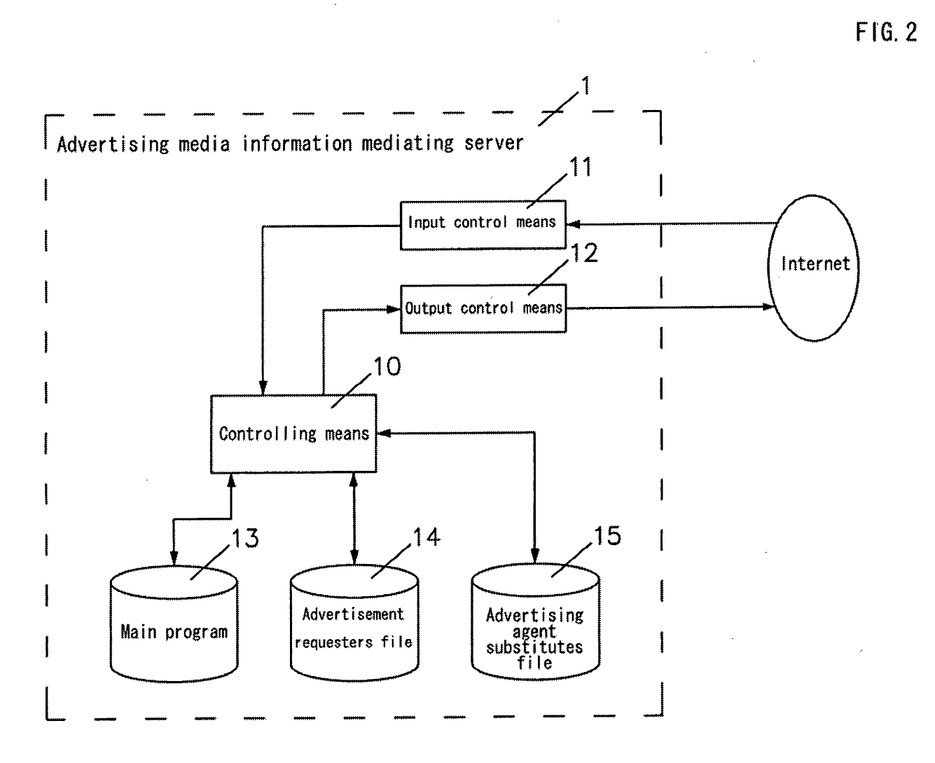

Next, the configuration of the server will be described in detail. FIG. 2 is a block diagram illustrating the configuration of the server 1. In the drawing, reference numeral 10 denotes a control unit constituted by a CPU, which controls respective units, transfers data, performs various calculations and stores data temporarily. Reference numeral 11 denotes an input control unit for controlling data that are inputted from terminals connected thereto via the internet. Reference numeral 12 denotes an output control unit for controlling data that are outputted to the terminals. Reference numerals 13 to 15 denote storage units, respectively, in which the following files are stored and memorized.

Firstly, the storage unit 13 stores a main program. The main program is such as to be used in the control unit 10 and is constituted by, for example, a program for displaying an input screen on the display unit of the terminal and a retrieval program for obtaining required information by retrieving conditions.

The storage unit 14 stores an advertisement requester file. The advertisement requester file is such as to be prepared for each advertisement request number and is constituted by information regarding the advertisement requester, information regarding an advertising target that is inputted from the terminal 2 by the advertisement requester and information regarding advertising conditions.

The storage unit 15 stores an advertising agent substitute file. The advertising agent substitute file is such as to be prepared for each advertisement request number and is constituted by information regarding the advertising agent substitute and information regarding advertising service substitution conditions that are inputted from the terminal 3 by the advertising agent substitute.

Next, the operation of the embodiment will be described. Here, the terminals 2, 3, 4 perform communications which are not connected to the server 1, respectively, and when the terminals 2, 3, 4 are connected to the server 1, the control unit 10 detects the connections via the input control unit 11 and controls the terminals 2, 3, 4 in accordance with the main program.

[Registration on the Server by the Advertisement Requester]

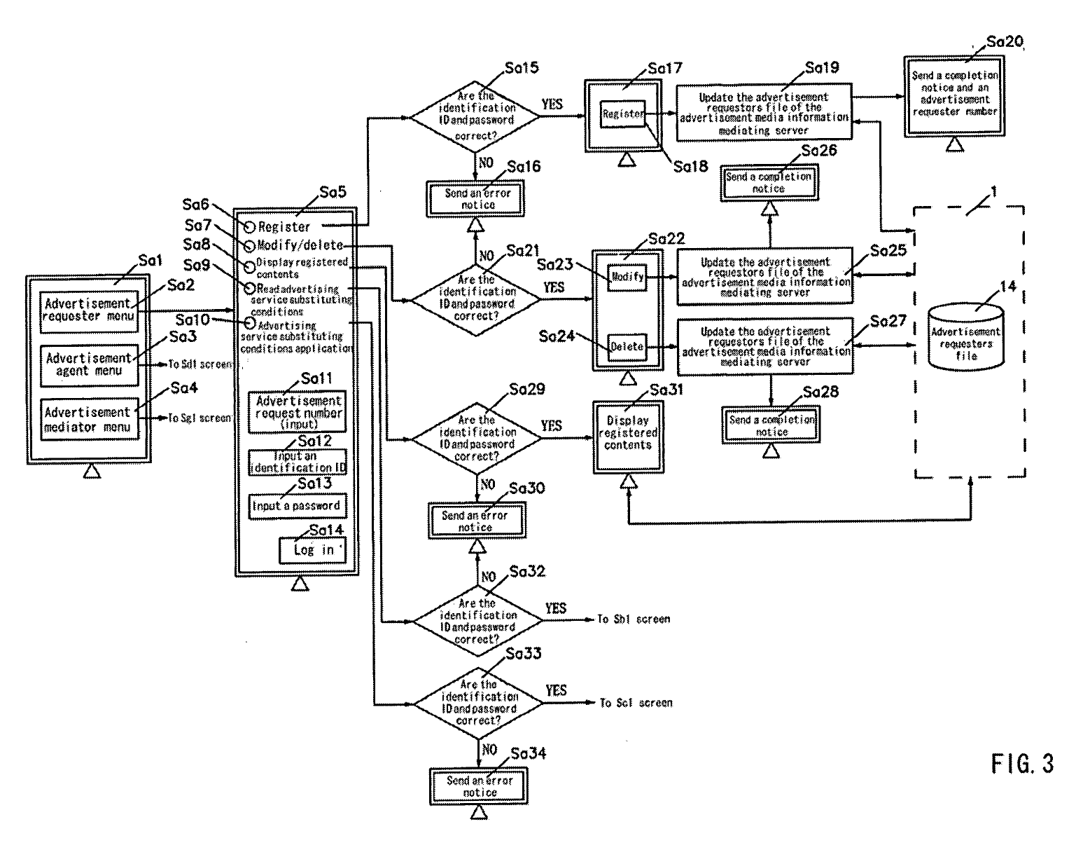

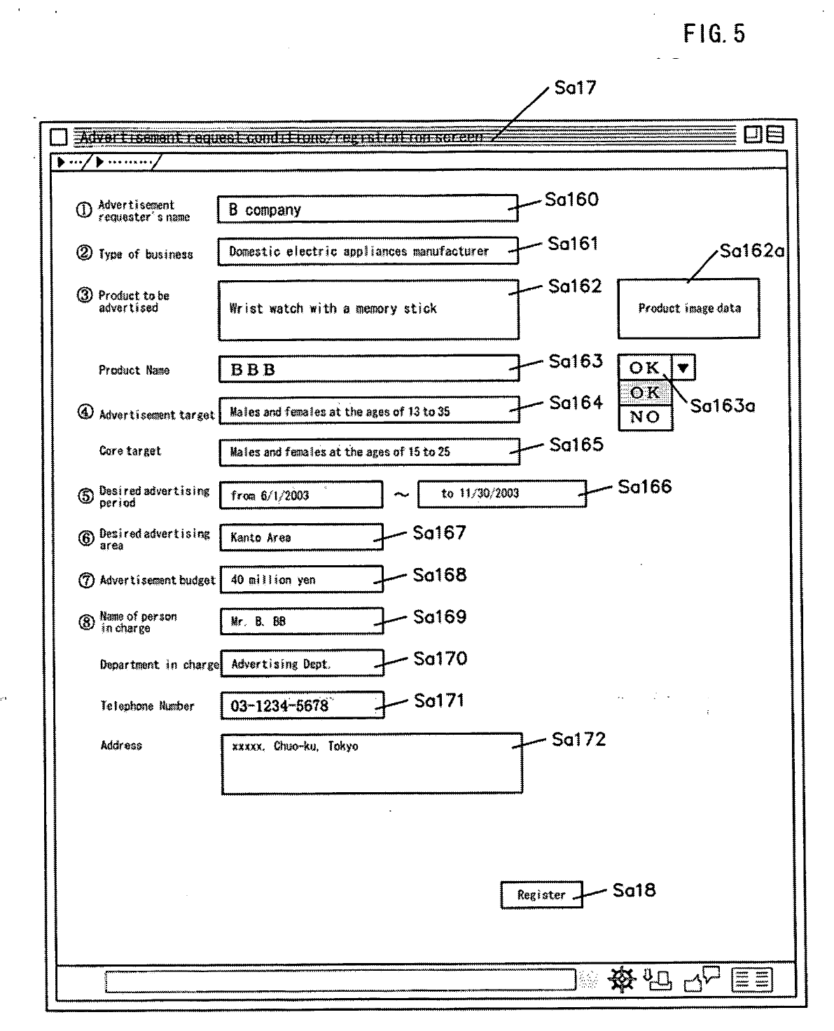

Firstly, a registration operation by the advertisement requester will be described. FIG. 3 is a flowchart illustrating the registration operation by the advertisement requester. When a predetermined URL is designated in the terminal 2, a menu screen denoted at Sa1 is displayed. Here, when an advertisement requester menu button denoted by reference numeral Sa2 is pressed, an advertisement requester menu screen denoted by at Sa5 is displayed. Here, when a new advertisement requester condition is registered, a check button denoted by reference numeral Sa6 is pressed, an identification ID that is obtained after a predetermined agreement is made is inputted at Sa12, a password is inputted at Sa13, and a log in button is pressed at Sa14, the flow proceeds to a step Sa15, where whether or not the identification ID and the password are correct is determined. If the identification ID and the password are not correct, proceed to a screen at Sa16, where an error is notified. If the identification ID and the password are correct, proceed to a screen at Sa17, and a screen as shown in FIG. 5 is displayed. Here, for example, the name of the advertisement requester is inputted at Sa160, the type of business is inputted at Sa161, a product which is desired to be advertised is inputted at Sa162, an image data of the product desired to be advertised is inputted at Sa162, and the name of the product is inputted at Sa163. At Sa163a, whether or not the name of the product is displayed can be selected in a pull-down fashion. Here, when the acceptance of the display or OK is selected, the name of the product is displayed when the name of the product is displayed on an advertisement request conditions viewing screen and an advertisement request conditions retrieving screen after the data is registered, whereas when the rejection of the display or NO is selected, the name of the product is not displayed when the name of the product is displayed on the advertisement request conditions viewing screen and the advertisement request conditions retrieving screen after the data is registered. An advertising target is inputted at Sa164, a core target of the advertising target is inputted at Sa165, a desired advertising period is inputted at Sa166, a desired advertising area is inputted at Sa167, an advertising budget is inputted at Sa168, the name of a responsible person is inputted at Sa169, the name of a section to which the responsible person belongs is inputted at Sa170, a telephone number for the section to which the responsible person belongs is inputted at Sa171, and the address of a place where the advertisement requester resides is inputted at Sa172.

When a registration button is pressed at Sa18 after the input of the required items has been completed, proceed to a step Sa19, where the inputted data are stored on an advertisement requester file 14 in the advertising media information mediating server 1, and an advertisement request number is given. Thereafter, proceed to a screen at Sa20, where the completion of registration and the advertisement request number so given are notified.

[Modification by the Advertisement Requester]

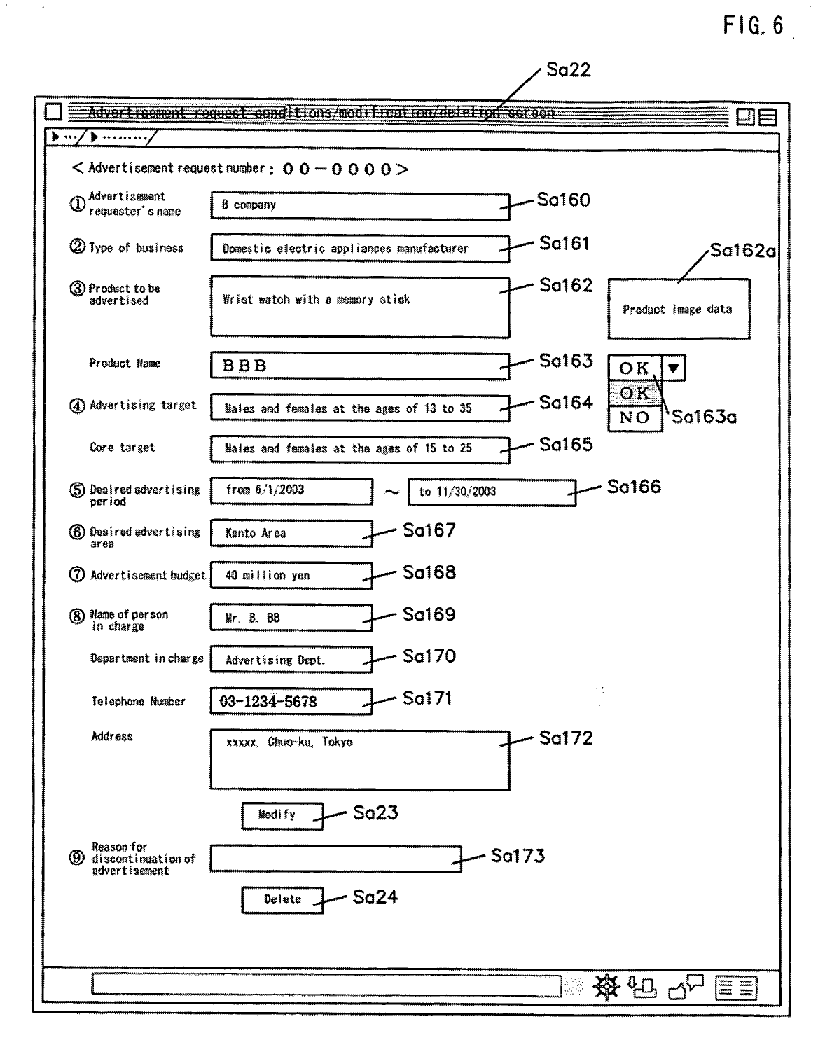

When modifying advertising service substituting conditions that have already been registered on the screen at Sa5, a check button is pressed at Sa7, an advertisement request number that is notified after the registration of an advertising service substitution condition that is to be modified has been completed for the first time is inputted at Sa11, an identification ID that is obtained after a predetermined agreement has been made is inputted at Sa12, a password is inputted at Sa13, and a log in button is depressed at Sa14. Then, proceed to a step Sa21, where whether or not the identification ID and the password are correct is determined. If the identification ID and the password are not correct, proceed to Sa16, where an error is notified on a screen. If the identification ID and the password are correct, proceed to Sa22, where a data on the advertisement request number that is stored on the advertisement requester file 14 in the advertising mediator server 1 is read out on a screen, and the data and the number are displayed on a screen as shown in FIG. 6. Here, when the contents of a modification are inputted in any locations among locations denoted by reference numerals Sa160 to Sa172 and a modification button is depressed at Sa23, the data on the advertisement request number that are registered on the advertisement requester file 14 in the advertising media information mediating server 1 are updated based on the data so inputted. Thereafter, proceed to Sa26, where the completion of modification is notified on a screen.

[Deletion by the Advertisement Requester]

When deleting a registered advertising service substitution condition at Sa5, the check button is depressed at Sa7, an advertisement request number that is notified after the registration of an advertising service substitution condition that is to be deleted has been completed for the first time is inputted at Sa11, the identification ID that is obtained after the predetermined agreement has been made is inputted at Sa12, the password is inputted at Sa13, and the log in button is depressed at Sa14. Then, proceed to the step Sa21, where whether or not the identification ID and the password are correct is determined. If the identification ID and the password are not correct, proceed to Sa16, where an error is notified on the screen. If the identification ID and the password are correct, proceed to Sa22, where the data on the advertisement request number that is stored on the advertisement requester file 14 in the advertising mediator server 1 is read out on the screen, and the data and the number are displayed on a screen as shown in FIG. 6. Here, when a deletion button is depressed at Sa24 after a reason for discontinuation has been inputted in an input box at Sa173, proceed to a step Sa27, where a deletion flag is imparted to the data on the advertisement request number that are stored in the advertisement requester file 14 in the advertising media information mediating server 1. Thereafter, proceed to Sa28, where the completion of preparation for the deletion is notified on a screen.

[Perusal of Advertisement Request Conditions by the Advertisement Requester]

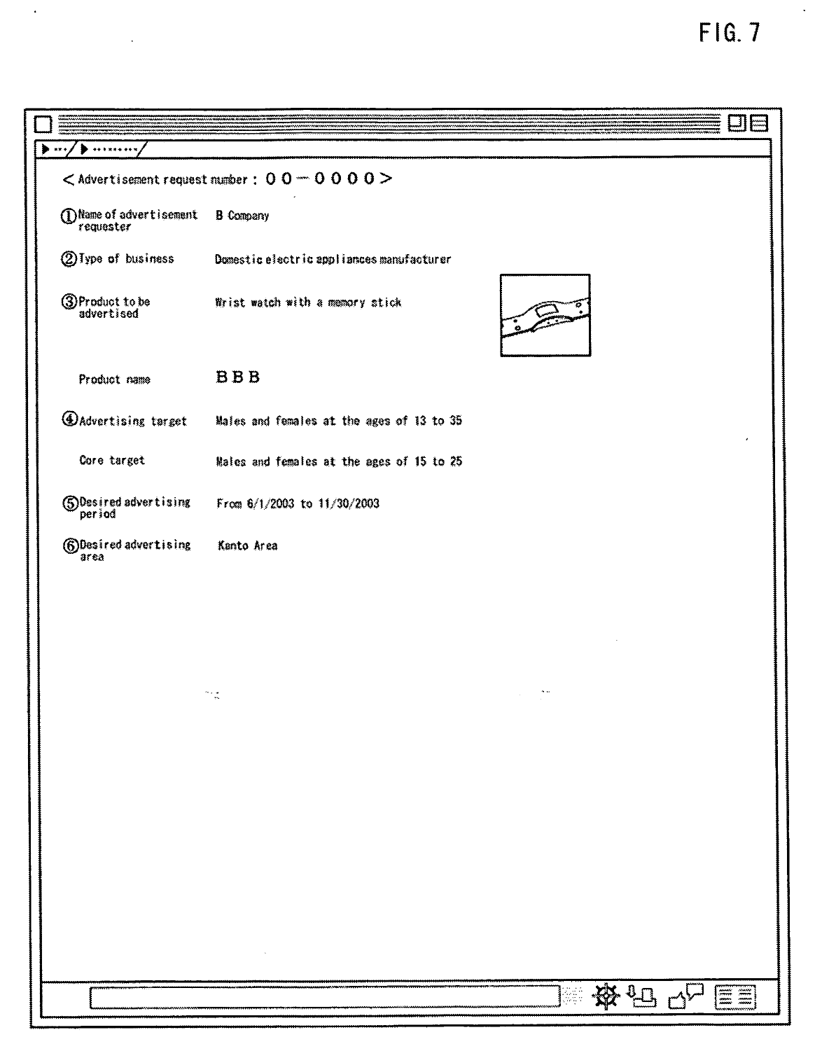

When perusing advertisement request conditions that have already been registered on the screen at Sa5, a check button is depressed at Sa8, the advertisement request number that is notified after the advertise request conditions have been registered for the first time is inputted at Sa11, the identification ID that is obtained after the predetermined agreement has been made is inputted at Sa12, the password is inputted at Sa13, and the log in button is depressed at Sa14. Then, proceed a step Sa29, where whether or not the identification ID and the password are correct is determined. If the identification ID and the password are not correct, then, proceed to a step Sa30, where an error is notified on a screen. If the identification ID and the password are correct, then, proceed to Sa31, where data on the advertisement request number that are stored on the advertisement requester file 14 on the advertising media information mediating server 1 are read out, whereby the data and the number can be verified on a screen as shown in FIG. 7. As this occurs, not all the output items of the data on the advertisement request conditions are displayed but the output of part of the output items may be restricted with a view to keeping the information secret.

[Perusal of Advertising Service Substitution Conditions by the Advertisement Requester]

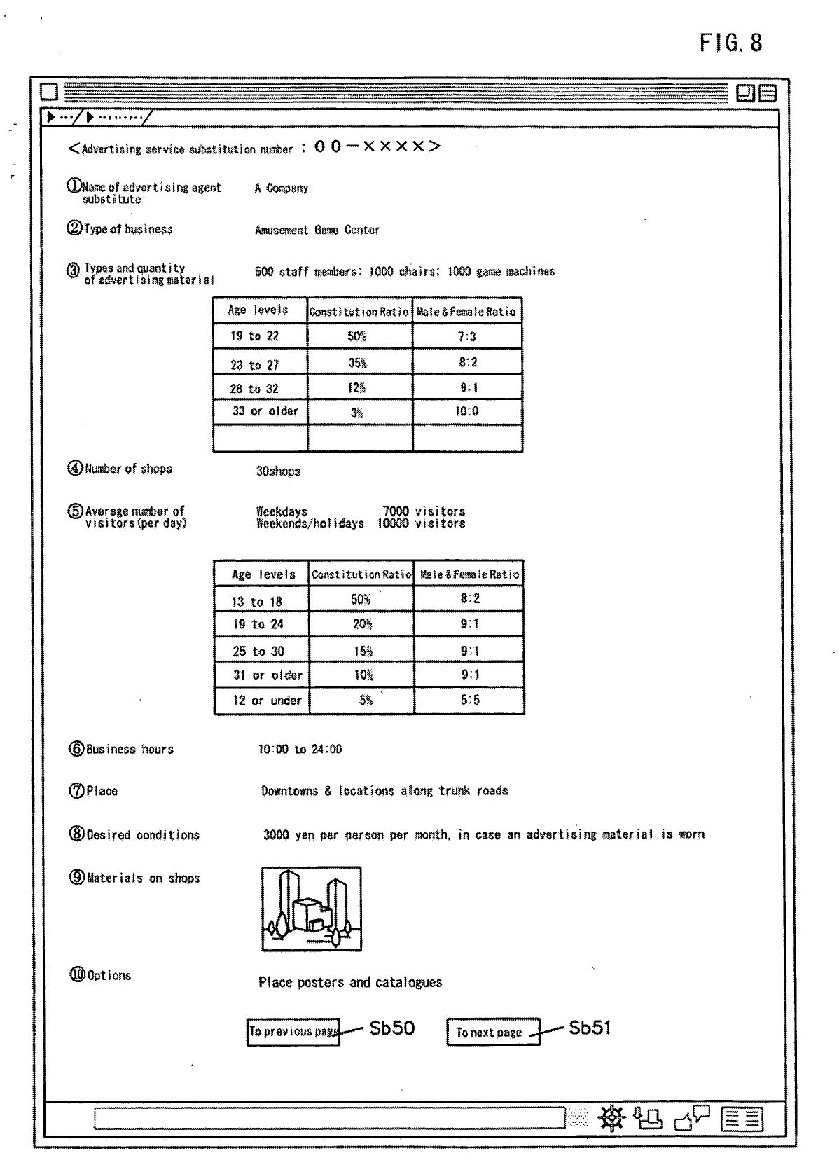

When the advertisement requester peruses advertising service substitution conditions that have already been registered on a screen at Sa5, a check button for perusal of the advertising service substituting conditions is depressed at Sa9, the identification ID that is obtained after the predetermined agreement has been made is inputted at Sa12, the password is inputted at Sa13, and the log in button is depressed at Sa14. Then, proceed to a step Sa32, where whether or not the identification ID and the password are correct is determined. If the identification ID and the password are not correct, proceed to Sa30, where an error is notified on a screen. If the identification ID and the password are correct, proceed to Sb1, where if a list of advertising service substitution conditions is perused on a screen, when a check button is pressed at Sb2 and a next button is depressed at Sb4, all the data on the advertising service substitution conditions that are stored on an advertising agent substitute file 15 in the advertising media information mediating server 1 are outputted, and each of the conditions is displayed together with the advertisement request number as shown in FIG. 8. Here, when a previous page button is depressed at Sb50, the previous data is displayed, whereas when a next page button is depressed at Sb51, the next data is displayed.

Note that as to shop information on photographs of a shop, the number of employees, residing address, and business hours among the advertising service substitution conditions, the shop information posted on a predetermined home page URL to which links are provided may be verified by accessing the home page.

[Retrieval of the Advertising Service Substitution Conditions by the Advertisement Requester]

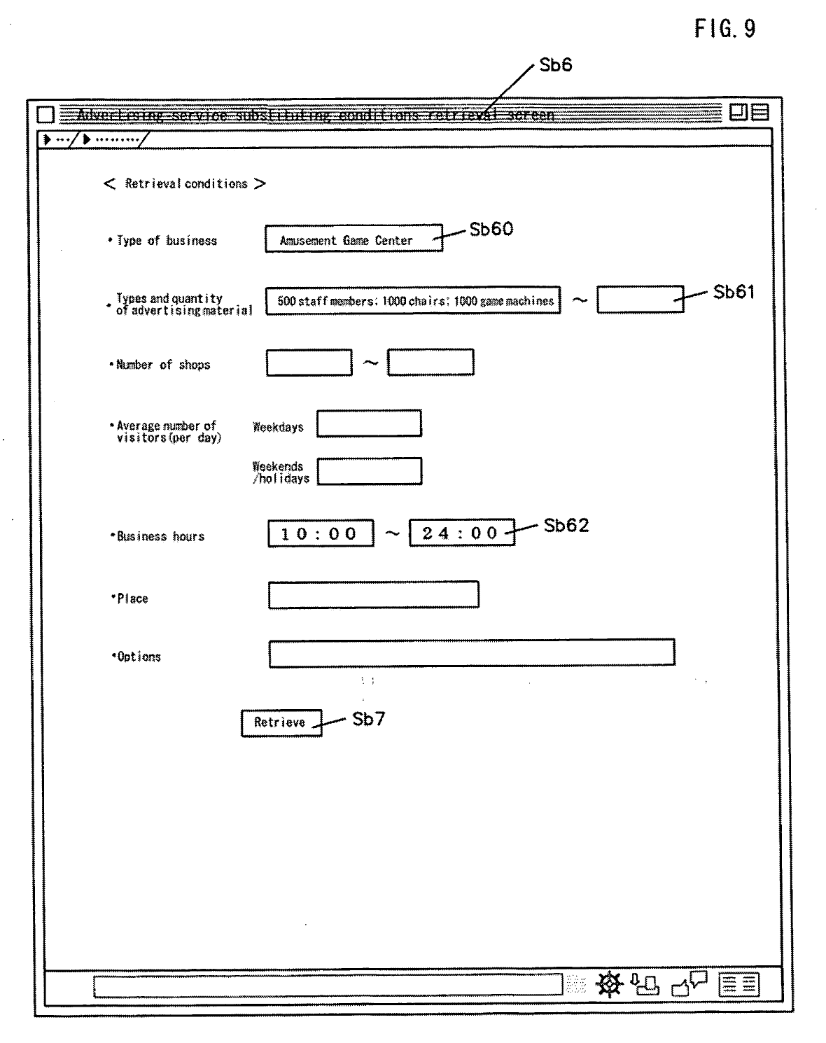

When retrieving the advertising service substitution conditions on a screen at Sb1, a check button for retrieving the advertising service substitution condition is depressed at Sb3, and a next button is depressed at Sb4. Then, proceed to Sb6, where a retrieval screen as shown in FIG. 9 is displayed. Here, when inputting retrieval conditions in an arbitrary fashion, for example, the type of business at Sb60, the number of people who wear advertising materials at Sb61 and business hours at Sb62, and a retrieval button is depressed at Sb7, then, proceed to Sb8, where a character string retrieval or a numerical retrieval is performed for each retrieval item of the retrieval conditions among the advertising service substation conditions that are stored on the advertising agent substitute file 15 in the advertising media information mediating server 1 on a screen, and if there are matching data, all the matching data are outputted, and each data is displayed together with the advertising substitution number as shown in FIG. 8. Here, when the previous page button is depressed at Sb50, the previous data are displayed, whereas when the next page button is depressed at Sb51, the next data are displayed.

[Application for Advertising Service Substitution Conditions by the Advertisement Requester]

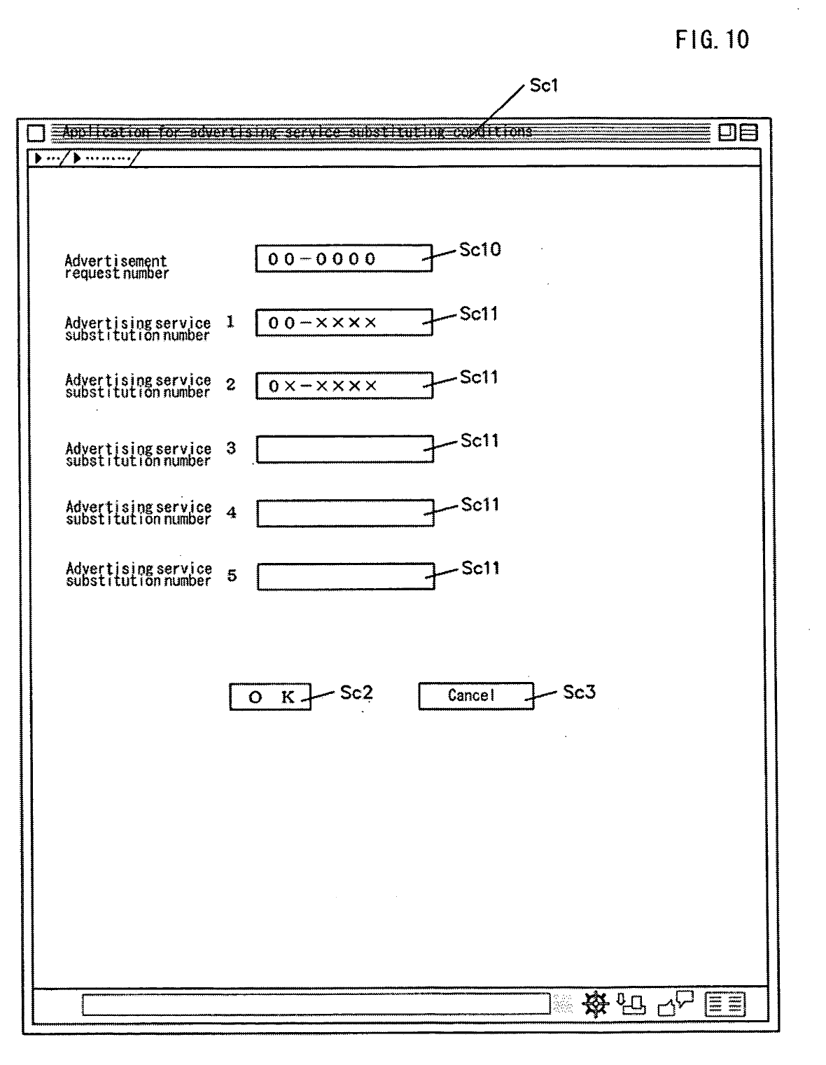

Then, an operation will be described which is performed by the advertisement requester when the advertisement requester applies for a negotiation for agreement with an advertising agent substitute who can provide conditions which are desired by the advertisement requester among the advertising service substitution conditions that have already been registered. A check button for application for advertising service substitution conditions is depressed at Sa10 using the screen at Sa5, the identification ID that is given after the predetermined agreement has been made is inputted at Sa12, the password is inputted at Sa13, and the log in button is depressed at Sa14. Then, proceed to a step Sa33, where the identification ID and the password are correct or not is determined. If the identification ID and the password are not correct, then, proceed to Sa34, where an error is notified on a screen. If the identification ID and the password are correct, then, proceed to Sc1 shown in FIG. 10, where an advertisement request number for advertising service substitution conditions for an advertising target under negotiation is inputted by the advertisement requester on a screen at Sc10, and a desired advertising substitution number is inputted at Sc11. Then, when an OK button is depressed at Sc2, an application flag is set on data on the advertisement request number that is stored on the advertisement requester file 14 in the advertising media information mediating server 1, and furthermore, the advertising substitution number so inputted is imparted to the same data.

[Registration to the Server by the Advertising Agent Substitute]

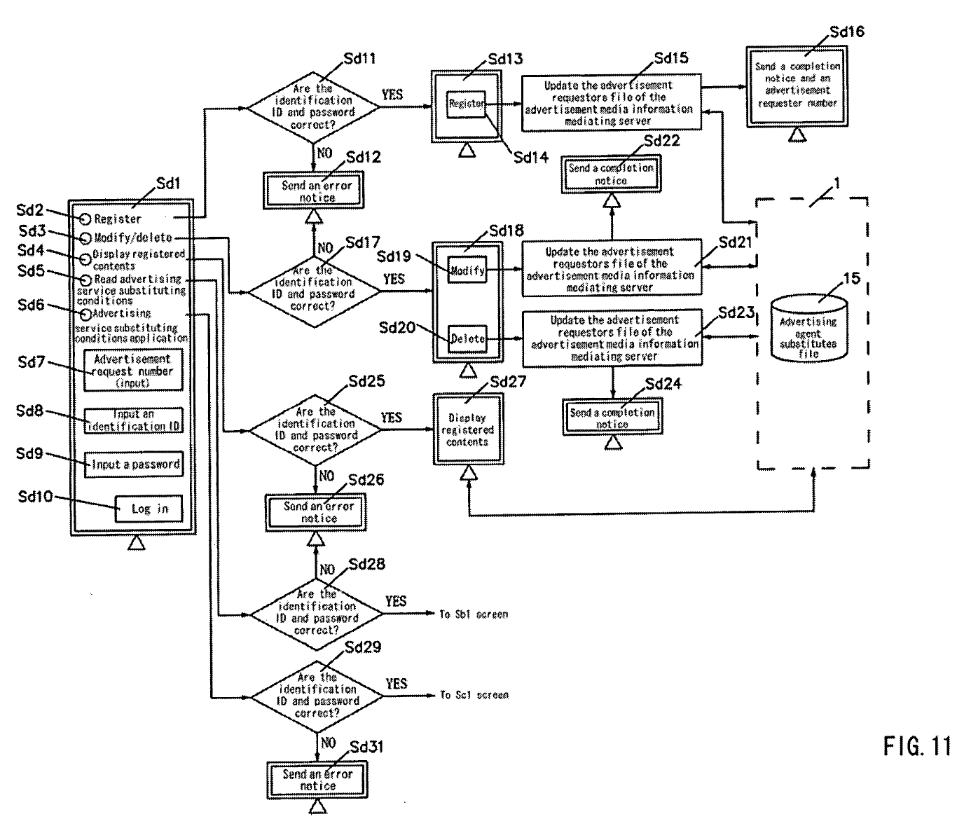

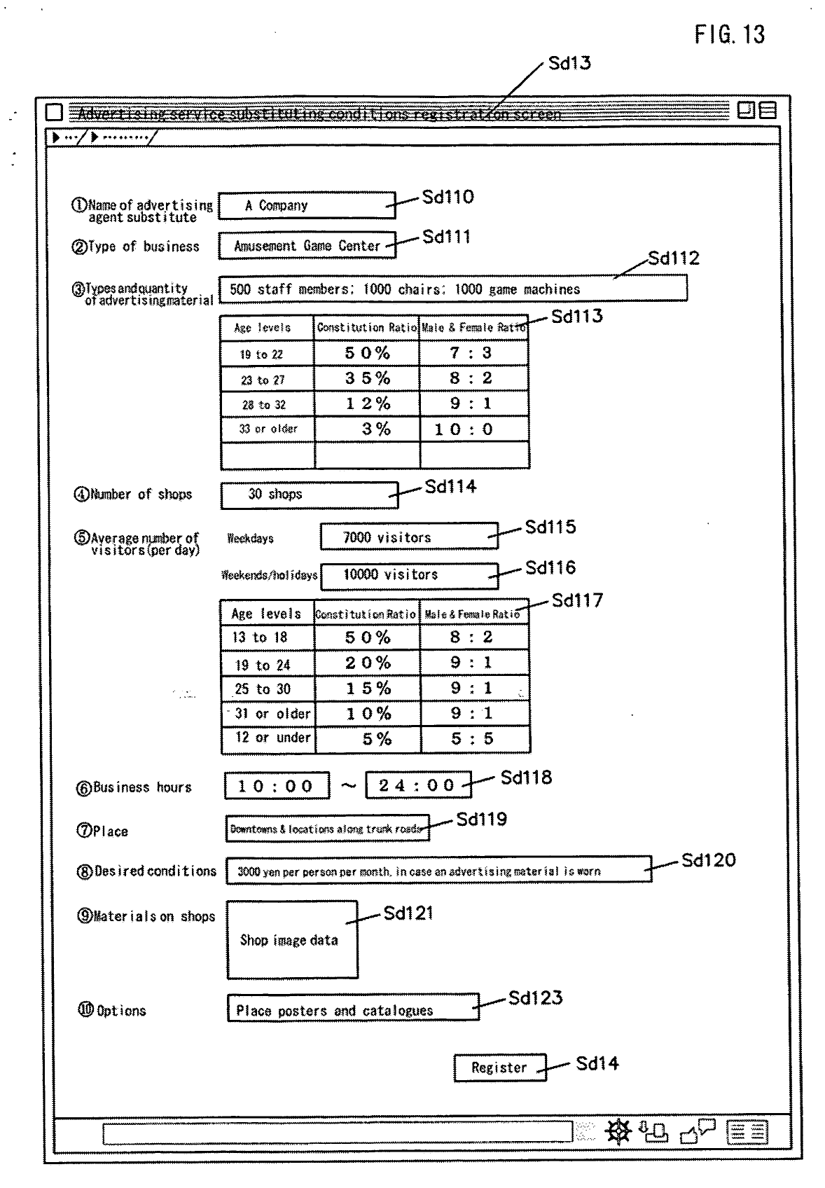

Next, a registration operation by the advertising agent substitute will be described. FIG. 11 is a flowchart illustrating a registration operation performed by the advertising agent substitute. When a predetermined URL is designated on the terminal 3, the menu screen shown at Sa3 is displayed. Here, when the advertising agent substitute menu button is depressed at Sa3, an advertising agent substitute menu screen at Sd1 in FIG. 11 is displayed. Here, when registering a new advertising substitution condition, a check button is depressed at Sd2, the identification ID that is given after the predetermined agreement has been made is inputted at SdB, the password is inputted at Sd9, and a log in button is depressed at Sd10. Then, proceed to a step Sd11, where whether or not the identification ID and the password are correct is determined. If the identification ID and the password are not correct, proceed to Sd12, where an error is notified on a screen. If the identification ID and the password are correct, proceed to Sd13, where a screen as shown in FIG. 13 is displayed. Here, for example, the name of the advertising agent substitute is inputted at Sd110, the type of business is inputted at Sd111, a material to which advertisement is applied and the quantity of the material are inputted at Sd112, a detailed configuration of target people who wear the material is inputted in a table form at Sd113, the number of shops is inputted at Sd114, the average number of people who visit the shops on weekdays is inputted at Sd115, the average number of people who visit the shops on weekends or holidays is inputted at Sd116, a detailed configuration of the visitors is inputted in a table form at Sd117, business hours are inputted at Sd118, a place is inputted at Sd119, desired conditions are inputted at Sd119, desired conditions are inputted at Sd120, and in the event that there are photographs showing the exterior and interior appearances of the shops, images or visual data thereof are inputted at Sd121. As optional items, there are items such as whether or not posters are posted, types of pamphlets, whether or not catalogues, leaflets and flyers are placed, whether or not sampling is carried out (distribution of test products), whether or not a visual image is broadcast, whether or not a music is broadcast, whether or not announcements are made for notification and description, whether or not campaign products are sold, whether or not products are displayed for reservation, which place is to be provided (in front of the shop, part of the interior of the shop or parking lot of the shop), and whether or not any cooperation such as holding an event is available. When a registration button is depressed at Sd14 after the input of the required items has been completed, then, proceed to a step Sd15, where the input data are stored on the advertising agent substitute file 15 in the advertising media information mediating server 1, and an advertising substitution number is imparted. Thereafter, proceed to Sd16, where a notice of completion of registration and the advertising substitution number are notified on a screen.

Note that in the event that the advertising agent substitute himself or herself has a server or borrows part of a server from a provider so as to open a home page on the server where ship information such as photographs of a shop, the number of employees, residing address, and business hours is posted, the registration of the shop information may be omitted by extending a link to the home page URL.

[Modification by the Advertising Agent Substitute]

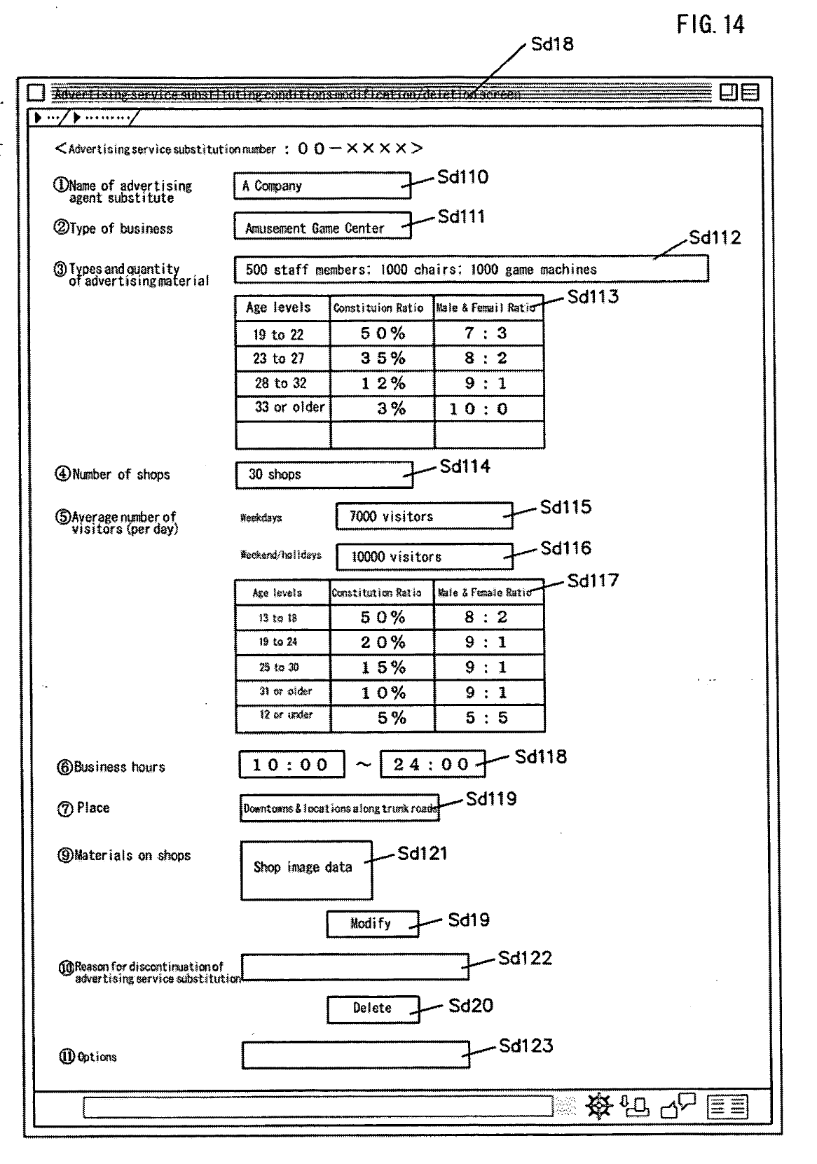

When modifying advertising service substituting conditions that have already been registered on the screen at Sd1, a check button is pressed at Sd3, an advertising substitution number that is notified after the registration of an advertising service substitution condition that is to be modified has been completed for the first time is inputted at Sd7, the identification ID that is obtained after the predetermined agreement has been made is inputted at Sd8, the password is inputted at Sd9, and a log in button is depressed at Sd10. Then, proceed to a step Sd17, where whether or not the identification ID and the password are correct is determined. If the identification ID and the password are not correct, proceed to Sd12, where an error is notified on a screen. If the identification ID and the password are correct, proceed to Sd18, where a data on the advertising substitution number that is stored on the advertising agent substitute file 15 in the advertising mediator server 1 is read out on a screen, and the data and the number are displayed on a screen as shown in FIG. 14. Here, when attempting to modify the data, the contents of a modification are inputted in any locations among locations denoted by reference numerals Sd110 to Sd123 and a modification button is depressed at Sd19, then proceed to a step Sd21, the data on the advertising substitution number that are registered on the advertising agent substitute file 15 in the advertising media information mediating server 1 are updated based on the data so inputted. Thereafter, proceed to Sd22, where the completion of modification is notified on a screen.

[Deletion by the Advertising Agent Substitute]

When deleting a registered advertising service substitution condition at Sd3, the check button is depressed at Sd3, an advertising substitution number that is notified after the registration of an advertising service substitution condition that is to be deleted has been completed for the first time is inputted at Sd7, the identification ID that is obtained after the predetermined agreement has been made is inputted at Sd8, the password is inputted at Sd9, and the log in button is depressed at Sd10. Then, proceed to the step Sd17, where whether or not the identification ID and the password are correct is determined. If the identification ID and the password are not correct, proceed to Sd12, where an error is notified on the screen. If the identification ID and the password are correct, proceed to Sd18, where the data on the advertising substitution number that is stored on the advertising agent substitute file 15 in the advertising media information mediating server 1 is read out on the screen, and the data and the number are displayed on a screen as shown in FIG. 14. Here, when a deletion button is depressed at Sd20 after a reason for discontinuation which deletes the advertising service substitution conditions has been inputted in an input box at Sd123, proceed to a step Sd23, where a deletion flag is imparted to the data on the advertising substitution number that are stored in the advertising agent substitute file 15 in the advertising media information mediating server 1. Thereafter, proceed to Sd24, where the completion of preparation for the deletion is notified on a screen.

[Perusal of Advertising Service Substitution Conditions by the Advertising Agent Substitute]

When perusing advertising service substitution conditions that have already been registered on the screen at Sd1, a check button is depressed at Sd4, the advertising substitution number that is notified after the advertising service substitution conditions that are desired to be perused have been registered for the first time is inputted at Sd7, the identification ID that is obtained after the predetermined agreement has been made is inputted at Sd8, the password is inputted at Sd9, and the log in button is depressed at Sd10. Then, proceed a step Sd25, where whether or not the identification ID and the password are correct is determined. If the identification ID and the password are not correct, then, proceed to a step Sd26, where an error is notified on a screen. If the identification ID and the password are correct, then, proceed to Sd27, where data on the advertising substitution number that are stored on the advertising agent substitution file 15 on the advertising media information mediating server 1 are read out, whereby the data and the number are displayed on a screen as shown in FIG. 7.

Note that as to shop information on photographs of a shop, the number of employees, residing address, and business hours among the advertising service substitution conditions, the shop information posted on a predetermined home page URL to which links are provided may be verified by accessing the home page.

[Perusal of Advertisement Request Conditions by the Advertising Agent Substitute]

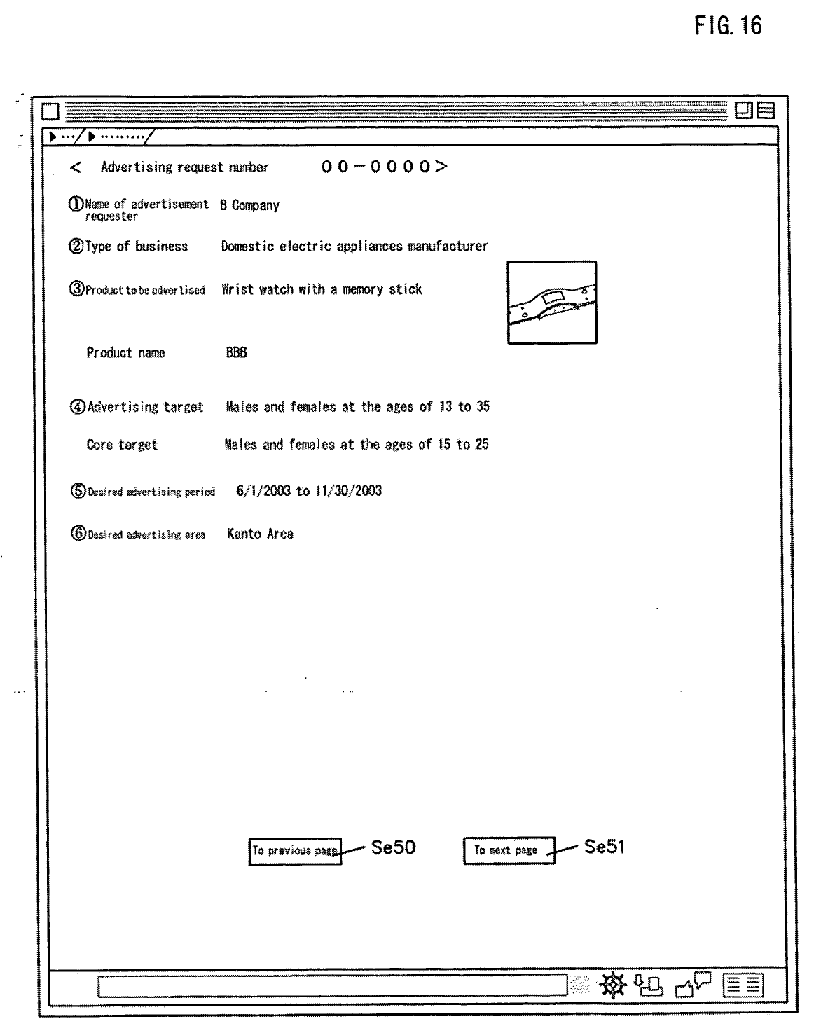

When the advertising agent substitute peruses advertisement request conditions that have already been registered on a screen at Sd1, a check button for perusal of the advertisement request conditions is depressed at Sd5, the identification ID that is obtained after the predetermined agreement has been made is inputted at Sd8, the password is inputted at Sd9, and the log in button is depressed at Sd10. Then, proceed to a step Sd28, where whether or not the identification ID and the password are correct is determined. If the identification ID and the password are not correct, proceed to Sd26, where an error is notified on a screen. If the identification ID and the password are correct, proceed to Se1, where if a list of advertisement request conditions is perused on a screen, when a check button is pressed at Se2 and a next button is depressed at Se4, all the data on the advertisement request conditions that are stored on the advertisement requester file 14 in the advertising media information mediating server 1 are outputted, and each of the conditions is displayed together with the advertisement request number as shown in FIG. 16. Here, when a previous page button is depressed at Se50, the previous data is displayed, whereas when a next page button is depressed at Se51, the next data is displayed. As this occurs, not all the output items of the data on the advertisement request conditions are displayed but the output of part of the output items may be restricted with a view to keeping the information secret.

[Retrieval of the Advertisement Request Conditions by the Advertising Agent Substitute]

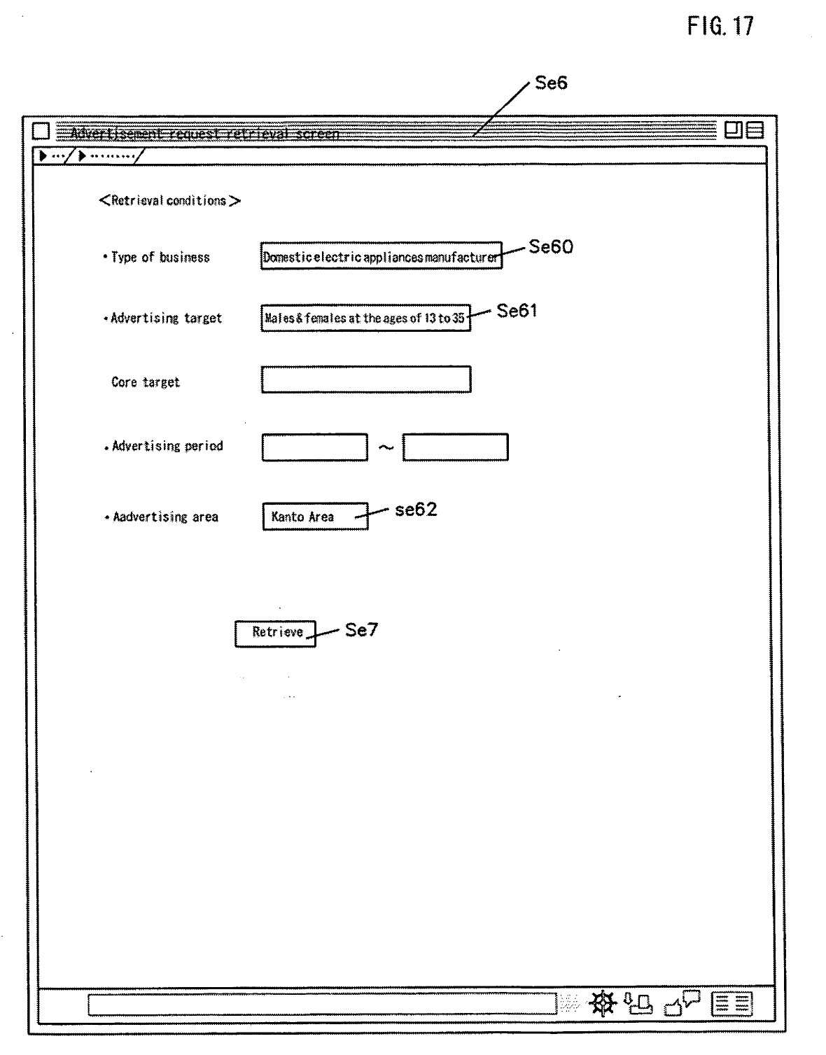

When retrieving the advertisement request conditions on a screen at Se1, a check button is depressed at Se3, and a next button is depressed at Se4. Then, proceed to Se6, where a retrieval screen as shown in FIG. 17 is displayed. Here, when inputting retrieval conditions in an arbitrary fashion, for example, the type of business at Se60, an advertising target at Se61, a desired advertising area at Se62, and a retrieval button is depressed at Se7, then, proceed to Se8, where a character string retrieval or a numerical retrieval is performed for each retrieval item of the retrieval conditions among the advertisement request conditions that are stored on the advertisement requester file 14 in the advertising media information mediating server 1 on a screen, and if there are matching data, all the matching data are outputted, and each data is displayed together with the advertising substitution number as shown in FIG. 16. Here, when the previous page button is depressed at Se50, the previous data are displayed, whereas when the next page button is depressed at Se51, the next data are displayed. As this occurs, not all the output items of the data on the advertisement request conditions are displayed but the output of part of the output items may be restricted with a view to keeping the information secret.

[Application for Advertisement Request Conditions by the Advertising Agent Substitute]

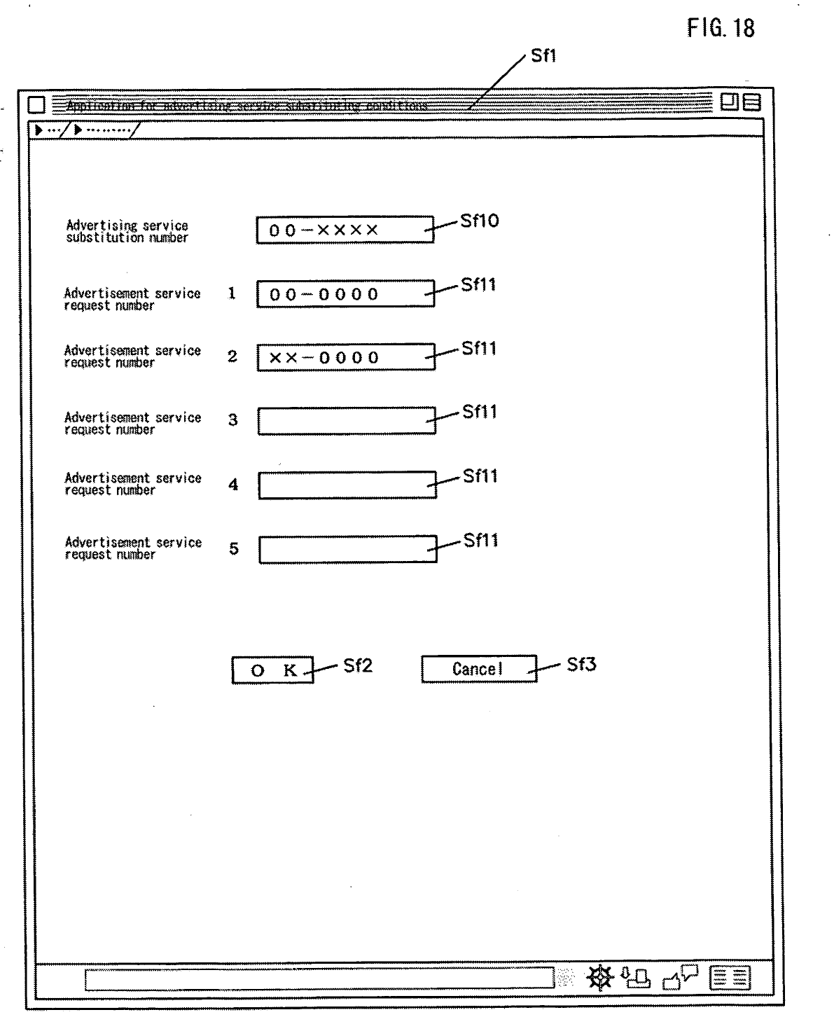

Then, an operation will be described which is performed by the advertising agent substitute when the advertising agent substitute applies for a negotiation for agreement with an advertisement requester who can provide conditions which are desired by the advertising agent substitute among the advertisement request conditions that have already been registered. A check button for application for advertising service substitution conditions is depressed at Sd1 using the screen at Sd6, the identification ID that is obtained after the predetermined agreement has been made is inputted at Sd8, the password is inputted at Sd9, and the log in button is depressed at Sd10. Then, proceed to a step Sd29, where the identification ID and the password are correct or not is determined. If the identification ID and the password are not correct, then, proceed to Sd31 where an error is notified on a screen. If the identification ID and the password are correct, then, proceed to Sf1 shown in FIG. 18, where an advertising substitution number for advertising service substitution conditions for an advertising target under negotiation is inputted by the advertising agent substitute on a screen at Sf10, and a desired advertisement request number is inputted at Sf11. Then, when an OK button is depressed at Sf2, an application flag is set on data on the advertising substitution number that is stored on the advertising agent substitute file 15 in the advertising media information mediating server 1, and furthermore, the advertisement request number so inputted is imparted to the same data.

[Advertising Mediator Menu]

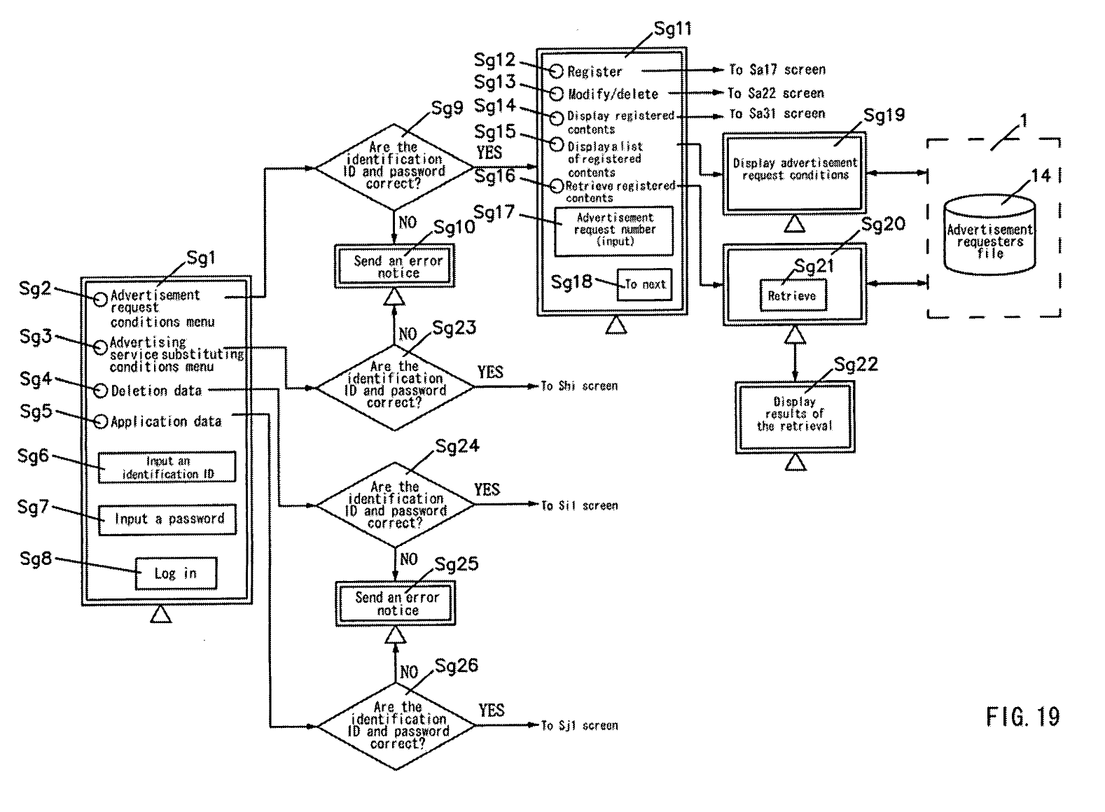

Next, the operation of an advertising mediator will be described. When a predetermined URL is designated on the terminal 3, a menu screen shown in FIG. 3 is displayed at Sa1. Here, when an advertising mediator menu button is depressed at Sa4, an advertising mediator menu screen shown in FIG. 19 is displayed at Sg1. Here, the registration, modification and deletion of data on the advertisement request conditions of the advertisement requester can be implemented, and any of an advertising service substitution condition menu where data on the registered advertising service substitution conditions can be perused, a menu where data on the advertisement requester or the advertising agent substitute to which the deletion flag is imparted can be perused and deleted, and a menu where data on the advertisement requester or the advertising agent substitute who has filed an application or with whom the application has been filed can be perused.

[Operation to Advertisement Request Conditions Menu by the Advertising Mediator]

In the event that the advertisement request condition menu is selected on the screen at Sg1, when a check button for advertisement contents/conditions menu is depressed at Sg2, an advertising mediator identification ID is inputted at Sg6, a password therefor is inputted at Sg7, and a log in button is depressed at Sg8, proceed to a step Sg9, where whether or not the identification ID and the password are correct is determined. If the identification ID and the password are not correct, then proceed to Sg10, where an error is notified on a screen. If the identification ID and the password are correct, then, proceed to Sg11, where the advertisement request conditions menu screen is displayed.

[Registration of Advertisement Request Conditions by the Advertising Mediator]

Here, in the event that a new advertisement request condition is registered, when the check button is depressed at Sg12 and a next button is depressed at Sg18, the flow proceeds to a screen at Sa1. An operation that will follow is such as to have been described above.

[Modification or Deletion of Advertisement Request Conditions by the Advertising Mediator]

In the event that advertisement request conditions that have already been registered are modified or deleted, when the check button is depressed at Sg13, an advertisement request number that is notified after the advertisement request conditions which are desired to be modified or deleted have been registered for the first time is inputted at Sg17, and the next button is depressed at Sg18, the flow proceeds to a step Sa22 in FIG. 3. An operation that will follow is such as to have been described above. Furthermore, in the event that the advertising mediator attempts to modify or delete the advertisement request conditions that were inputted for the first time by the advertisement requester, the contents of the modification or deletion may be transmitted to a mail address of the advertisement requester which has been registered in advance.

[Perusal of Advertisement Request Conditions by the Advertising Mediator]

In the event that the registered advertisement contents/conditions are perused on a screen at Sg11, when the check button is depressed at Sg14, the advertisement request number that is notified after the advertisement request conditions which are desired to be perused have been registered for the first time is inputted at Sg17, and the next button is depressed at Sg18, the flow proceeds to a step Sa31 in FIG. 3. An operation that will follow is such as to have been described above. Note that in the event that the advertisement request conditions are attempted to be perused from the advertising mediator menu, as to output items of data on the advertisement request conditions which are to be displayed, all the items that are inputted may be designed to be outputted.

[Perusal of List of Advertisement Request Conditions by the Advertising Mediator]

In the event that a list of advertisement request conditions is attempted to be perused on a screen at Sg11, when the check button is depressed at Sg15 and the next button is depressed at Sg18, the flow proceeds to a screen at Sg19, where all the advertisement request conditions that are stored on the advertisement requester file 14 in the advertising media information mediating server 1 are outputted, and each of the information is displayed as shown in FIG. 16. Here, when a previous button is depressed at Se50, previous data are displayed, whereas when a next page button is depressed at Se51, next data are displayed. Note that in the event that the advertisement request conditions are attempted to be perused from the advertising mediator menu, as to output items of data on the advertisement request conditions which are to be displayed, all the items that are inputted may be designed to be outputted.

[Retrieval of Advertisement Request Conditions by the Advertising Mediator]

In the event that the registered advertisement request conditions are retrieved on a screen at Sg11, when the check button is depressed at Sg16 and the next button is depressed at Sg18, the flow proceeds to a screen at Sg20, where a retrieval screen as shown in FIG. 17 is displayed. Here, when inputting retrieval conditions in an arbitrary fashion, for example, the type of business at Se60, the advertising target at Se61, the desired advertising area at Se62, and the retrieval button is depressed at Se7, then, the flow proceeds to Sg22, where a character string retrieval or a numerical retrieval is performed for each retrieval item of the retrieval conditions among the advertisement request conditions that are stored on the advertisement requester file 14 in the advertising media information mediating server 1 on a screen, and if there are matching data, all the matching data are outputted, and each data is displayed together with the advertisement request number as shown in FIG. 16. Here, when the previous page button is depressed at Se50, the previous data are displayed, whereas when the next page button is depressed at Se51, the next data are displayed. Note that in the event that the advertisement request conditions are attempted to be perused from the advertising mediator menu, as to output items of data on the advertisement request conditions which are to be displayed, all the items that are inputted may be designed to be outputted.

[Operation to Advertising Service Substitution Conditions Menu by the Advertising Mediator]

In the event that the advertising service substitution condition menu is selected on the screen at Sg1, when a check button for advertising service substitution contents/conditions menu is depressed at Sg3, the advertising mediator identification ID is inputted at Sg6, the password therefor is inputted at Sg7, and the log in button is depressed at Sg8, the flow proceeds to a step Sg23, where whether or not the identification ID and the password are correct is determined. If the identification ID and the password are not correct, then the flow proceeds to Sg10, where an error is notified on a screen. If the identification ID and the password are correct, then, the flow proceeds to Sh21, where the advertising service substitution condition menu screen is displayed.

[Registration of Advertising Service Substitution Conditions by the Advertising Mediator]

Here, in the event that a new advertising service substitution condition is registered, when the check button is depressed at Sh2 and the next button is depressed at Sh8, the flow proceeds to a screen at Sd13 in FIG. 11. An operation that will follow is such as to have been described above.

[Modification or Deletion of Advertising Service Substitution Conditions by the Advertising Mediator]

In the event that advertising service substitution conditions that have already been registered are modified or deleted on a screen at Sh1, when the check button is depressed at Sh3, an advertisement request number that is notified after the advertisement request conditions which are desired to be modified or deleted have been registered for the first time is inputted at Sh7, and the next button is depressed at Sh8, the flow proceeds to a step Sd18 in FIG. 3. An operation that will follow is such as to have been described above. Furthermore, in the event that the advertising mediator attempts to modify or delete the advertisement request conditions that were inputted for the first time by the advertisement requester, the contents of the modification or deletion may be transmitted to a mail address of the advertisement requester which has been registered in advance.

[Perusal of Advertising Service Substitution Conditions by the Advertising Mediator]

In the event that the registered advertising service substitution conditions are perused on a screen at Sh1, when the check button is depressed at Sh4, the advertisement request number that is notified after the advertisement request conditions which are desired to be perused have been registered for the first time is inputted at Sh7, and the next button is depressed at Sh8, the flow proceeds to a screen at a step Sd27 shown in FIG. 11. An operation that will follow is such as to have been described above.

[Perusal of List of Advertising Service Substitution Conditions by the Advertising Mediator]

In the event that a list of advertising service substitution conditions is attempted to be perused on a screen at Sh1, when the check button is depressed at Sh5 and the next button is depressed at Sh8, the flow proceeds to a screen at Sh9, where data on all the advertisement request conditions that are stored on the advertising agent substitute file 15 in the advertising media information mediating server 1 are outputted, and each of the information is displayed together with the advertising substitution number as shown in FIG. 8. Here, when the previous button is depressed at Sb50, previous data are displayed, whereas when a next page button is depressed at Se51, next data are displayed.

[Retrieval of Advertising Service Substitution Conditions by the Advertising Mediator]

In the event that the registered advertising service substitution conditions are retrieved on a screen at Sh1, when the check button is depressed at Sh6 and the next button is depressed at Sh8, the flow proceeds to a screen at Sh10, where a retrieval screen as shown in FIG. 9 is displayed. Here, when inputting retrieval conditions in an arbitrary fashion, for example, the type of business at Se60, the advertising target at Se61, the desired advertising area at Se62, and the retrieval button is depressed at Se7, then, the flow proceeds to Sh12, where a character string retrieval or a numerical retrieval is performed for each retrieval item of the retrieval conditions among the advertising service substitution conditions that are stored on the advertising agent substitute file 15 in the advertising media information mediating server 1 on a screen, and if there are matching data, all the matching data are outputted, and each data is displayed together with the advertisement request number as shown in FIG. 8. Here, when the previous page button is depressed at Sb50, the previous data are displayed, whereas when the next page button is depressed at Sb51, the next data are displayed.

[Operation to Deletion Data Menu by the Advertising Mediator]

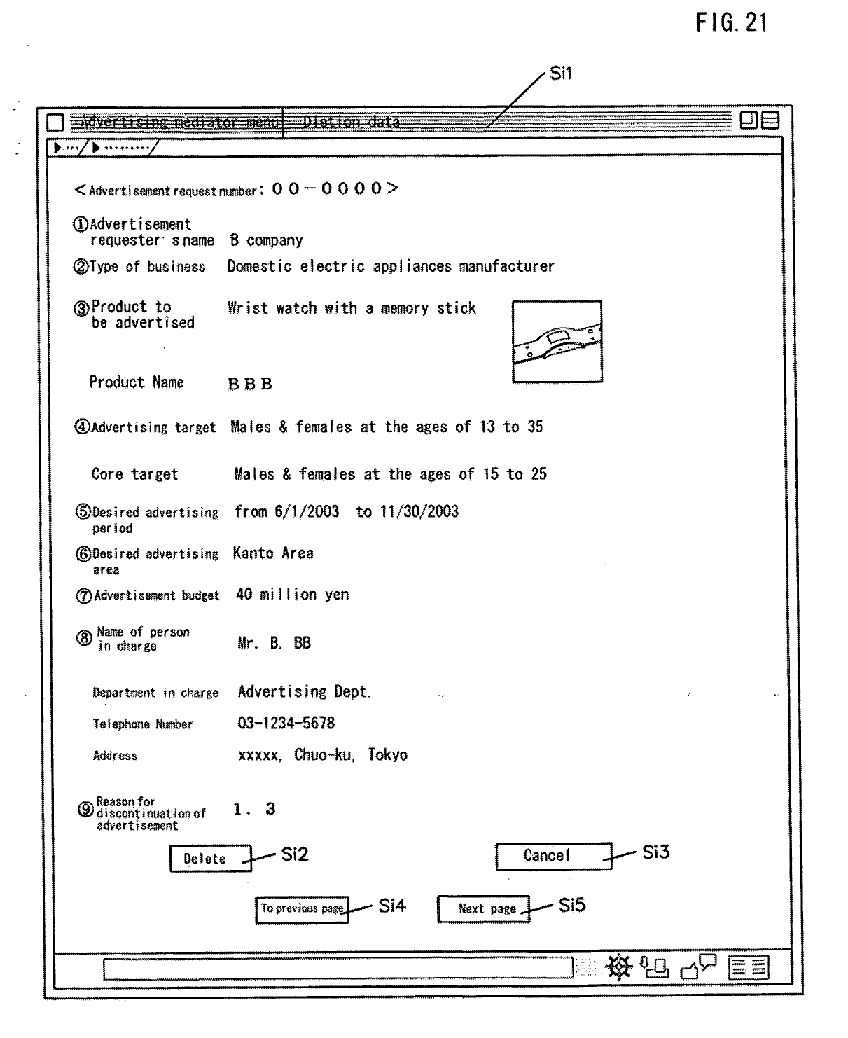

In the event that a deletion data menu is selected on the screen at Sg1, when a check button for the deletion data menu is depressed at Sg4, the advertising mediator identification ID is inputted at Sg6, the password therefor is inputted at Sg7, and the log in button is depressed at Sg8, the flow proceeds to a step Sg24, where whether or not the identification ID and the password are correct is determined. If the identification ID and the password are not correct, then the flow proceeds to Sg25, where an error is notified on a screen. If the identification ID and the password are correct, then, the flow proceeds to Si1, where of the advertisement request conditions data or the advertising service substitution condition data which are stored in the advertisement requester file 14 or the advertising agent substitute file 15 of the advertising media information mediating server 1, those on which a deletion flag is set are displayed. In the event that, for example, a screen as shown in FIG. 21 is displayed and a deletion button is depressed at Si2 with a view to deleting the relevant data, the data which are stored in the advertisement requester file 14 or the advertising agent substitute file 15 of the advertising media information mediating server 1 are deleted. In addition, in the event that the previous data are desired to be displayed, when a previous button is depressed at Si4, the relevant data are displayed, whereas in the event that the nest data are desired to be displayed, when a next button is depressed at Si5, the relevant data are displayed.

[Operation to Application Data Menu by the Advertising Mediator]

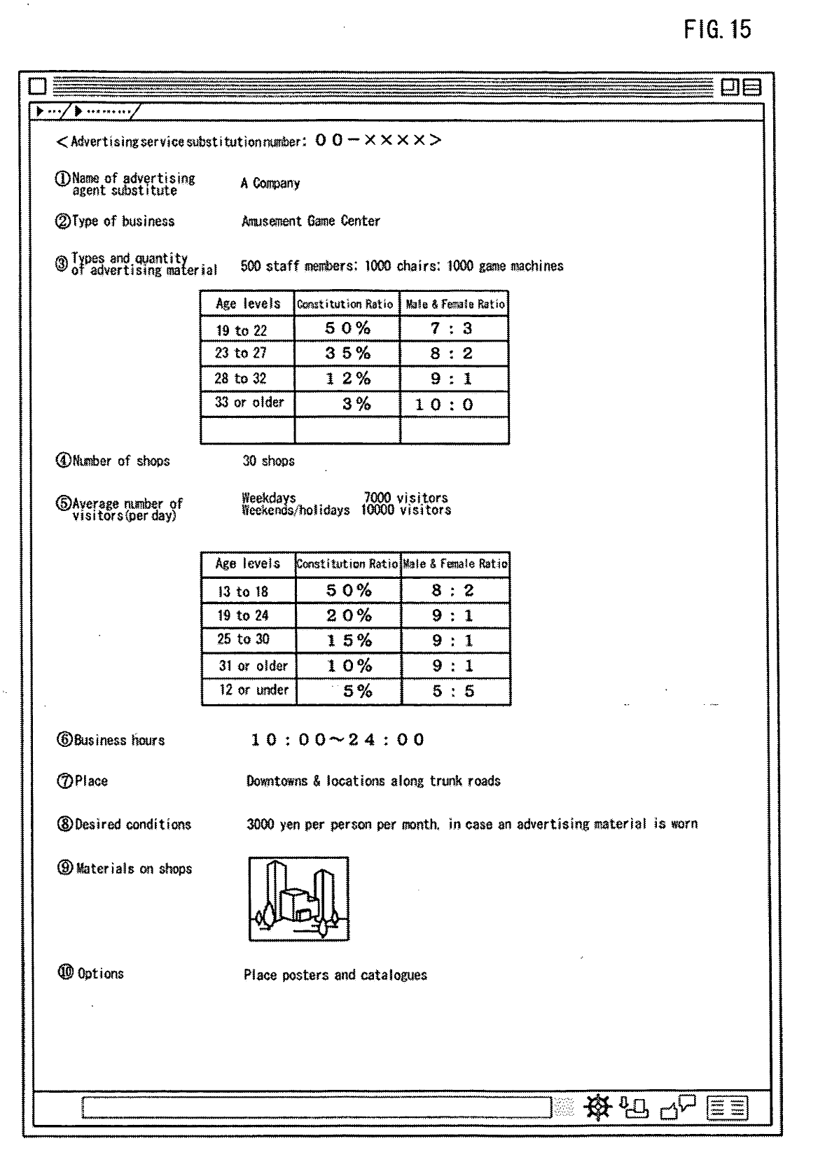

In the event that an application data menu is selected on the screen at Sg1, when a check button for the application data menu is depressed at Sg5, the advertising mediator identification ID is inputted at Sg6, the password therefor is inputted at Sg7, and the log in button is depressed at Sg8, the flow proceeds to a step Sg26, where whether or not the identification ID and the password are correct is determined. If the identification ID and the password are not correct, then the flow proceeds to Sg25, where an error is notified on the screen. If the identification ID and the password are correct, then, the flow proceeds to Sj1, where of the advertisement request conditions data or the advertising service substitution condition data which are stored in the advertisement requester file 14 or the advertising agent substitute file 15 of the advertising media information mediating server 1, those on which an application flag is set are displayed together with the data number and a number assigned and inputted for the data. Here, in the event that a button displaying the advertising substitution number so assigned and inputted is depressed at Sj2, data stored on the advertising agent substitute file 15 of the advertising media information mediating server 1 which corresponds to the number are displayed as shown in FIG. 15. The same flow will be followed in the case of data which are filed and inputted by the advertising agent substitute.

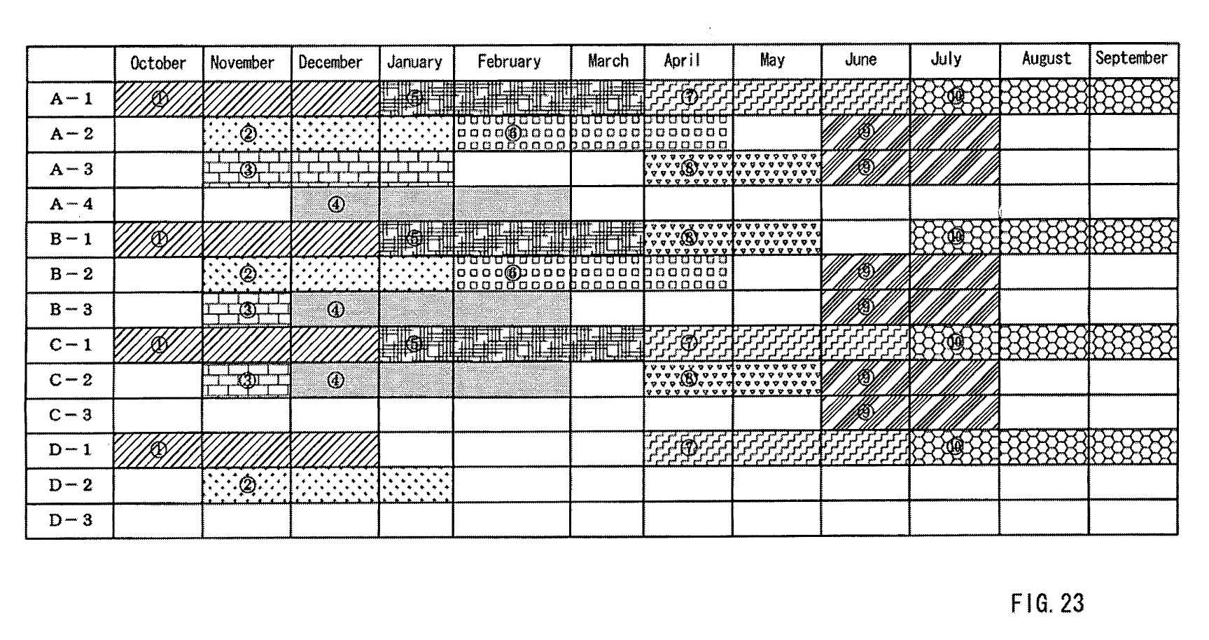

FIG. 23 illustrates a media schedules management table. The advertisement requester and the advertising agent substitute can retrieve this schedule management table on the host server. In the drawing, names of advertising agent substitutes are written from A-1 to D-3 in a vertical column, and a horizontal row indicates that various media are fixed in respective calendar months, whereby salespeople of advertising agent substitutes can perform sales activities for calendar months where no fixed schedules are written. In addition, there is a case where the advertising mediator performs sales activities upon request from the advertising agent substitutes and advertisement requesters.

The advertising mediator mediates between an advertisement requester and an advertising agent substitute whose conditions are met each other based on the advertisement request conditions and advertising service substitution conditions which are registered as has been described heretofore, so that the realization of an advertisement that is executed by the advertising agent substitute on behalf of the advertisement requester is attained by negotiating with both the parties for agreement and holding meetings on production of advertising materials. Note that a plurality of advertising agent substitute may make an advertising substitution contract with a single advertisement requester, or, on the contrary, a plurality of advertisement requesters may make an advertising contract with a single advertising agent substitute in which the advertising material is worn, used, displayed, sold, lent or distributed for advertisement. In addition, the advertising mediator may purchase the whole or part of the advertising service substitution conditions set by the advertising agent substitute so as to negotiate directly with the advertisement requester to make an advertising contract in which the advertising material is worn, used, displayed, sold, lent or distributed for advertisement.

Furthermore, while, in the embodiment that has been described heretofore, the configuration of the system is described such that the server 1 is connected with the terminals 2, 3, 4 via the internet, the invention is not limited thereto and any connecting form may be adopted between the server and the terminals. In addition, while, in the embodiment, the terminals that are connected to the server 1 are described as being the terminals 2, 3, 4, since there exist pluralities of advertisement requesters and advertisement request receivers in a normal situation, there may exist terminals other than the terminals 2, 3, 4. In addition, the terminal 4 of the advertising mediator may be directly connected with the server 1 rather than being connected with the server via the internet.

Industrial Applicability

According to the invention, since the advertisement requester can get executed an advertisement which can provide a strong visual impact when a person moves while wearing or using the advertising materials on the desired advertisement request conditions and can apply the advertisement to various advertising targets, a larger advertising effect can be expected.

On the other hand, in the event that what carries the advertisement is a business uniform, the advertising agent substitute can reduce the overhead costs involved in the business and can obtain earnings from the advertisement.

In addition, in the event that what carries the advertisement is a stage costume, the advertising agent substitute can save expenditures for costumes and for producing a stage and obtain earnings from the advertisement.

In addition, in the event that the advertisement requester is a sport team, the sport team, the expenditures for uniforms and sports things can be reduced and earnings can be obtained from the advertisement.

In addition, in the event that what carries the advertisement is part or the whole of a shop or facility, the owner of the shop or facility can reduce the expenditures therefor and can get earnings form the advertisement.

According to the invention, the advertisement requester can register the desired advertisement request conditions through a simple operation, whereas the advertising agent substitute can register the advertising service substitution conditions through a simple operation, whereby the advertisement requester can obtain information on the registered advertising service substitution conditions through a simple operation, and the advertising agent substitute can obtain information on the registered advertisement request conditions through a simple operation.

According to the invention, the advertisement requester can negotiate or proceed with a required transaction for agreement with a desired advertising agent substitute through a simple operation without spending much time, thereby making it possible for both the parties to proceed with the required transactions quickly and smoothly.

According to the invention, the advertising agent substitute can negotiate or proceed with a required transaction for agreement with a desired advertisement requester through a simple operation without spending much time, thereby making it possible for both the parties to proceed with the required transactions quickly and smoothly.

According to the aspect of the invention, the advertisement requester and the advertising agent substitute can select an advertising business partner from a wide variety of advertisement requesters and advertising agent substitutes without spending much time via the network.

According to the invention, since the input and output of information by other people than the advertisement requester, advertising agent substitute and advertisement mediator can be restricted, the safety and reliability of the system can be maintained high.

1. An advertising service substitution method in which an advertisement requester or an advertising mediator registers advertisement request conditions on an advertising media information mediating server, whereas an advertising agent substitute, who executes an advertisement on behalf of the advertisement requester, registers advertising service substitution conditions on the advertising media information mediating server, or the advertising mediator registers advertising service substitution conditions on the advertising media information mediating server, whereby when the advertisement requester and the advertising agent substitute retrieve the advertising service substitution conditions and the advertisement request conditions, respectively, via a network, and come to an agreement on the conditions, the advertisement requester pays part of or the whole of expenditures for advertising materials and advertisement, whereas the advertising agent substitute performs an advertisement on behalf of the advertisement requester by wearing and using the advertising materials and furthermore by posting posters, placing pamphlets, catalogues, leaflets and flyers, carrying out sampling (distribution of test products), broad casting a visual image, broadcasting pieces of music, making announcements for notification and description, selling campaign products, receiving reservations for and displaying products, providing a place (in front of a shop, part of the interior of the shop or parking lot of the shop), and cooperating in holding an event.

2. In a computer system for mediating information on advertising media, an advertising media information mediating system comprising: a function to encourage through a network an advertisement requester or an advertising mediator to input advertisement request conditions on advertising contents including the type of business of the advertisement requester, the name of a product and an advertising period, advertisement targets, and an advertising budget; a function to store the input information on an advertising media information mediating server; a function to encourage through the network an advertising agent substitute or the advertising mediator to input advertising service substitution conditions on the degree of exposure and state of an advertising location by image data on exterior and interior appearances of an advertisement posting space and visual data or character data and numerical data, the quantity of advertising materials and the number of people to which advertisement can be applied, advertising space and advertising charges; a function to store the input information on the advertising media information mediating server; a function to output the advertising service substitution conditions stored on the advertising media information mediating server in response to an output request by the advertisement requester or the advertising mediator from a terminal thereof; and a function to output the advertisement request conditions stored on the advertising media information mediating server in response to an output request by the advertising agent substitute or the advertising mediator from a terminal thereof.

3. An advertising media information mediating system as set forth in claim 2, comprising a retrieval function in which the advertisement requester and the advertising mediator can retrieve advertising service substitution conditions which match the desired conditions from the advertising service substitution conditions which are stored on the advertising media information mediating server.

4. An advertising media information mediating system as set forth in claim 2, comprising a function in which the advertising agent substitute and the advertising mediator can retrieve advertisement request conditions which match the desired conditions from the advertisement request conditions which are stored on the advertising media information mediating server.

5. An advertising media information mediating system as set forth in claim 3, comprising a function in which the advertising agent substitute and the advertising mediator can retrieve advertisement request conditions which match the desired conditions from the advertisement request conditions which are stored on the advertising media information mediating server.

6. An advertising media information mediating system as set forth in claim 5, comprising a function in which the advertisement requester can negotiate or proceed with a required transaction for agreement via the advertising media information mediating system with an advertising agent substitute who has inputted advertising service substitution conditions which match conditions desired by the advertisement requester from the advertising service substitution conditions which are stored on the advertising media information mediating server.

7. An advertising media information mediating system as set forth in claim 5, comprising a function in which the advertising agent substitute can negotiate or proceed with a required transaction for agreement via the advertising media information mediating system with an advertisement requester who has inputted advertisement request conditions which match conditions desired by the advertising agent substitute from the advertisement request conditions which are stored on the advertising media information mediating server.

8. An advertising media information mediating system as set forth in claim 6, comprising: a function to encourage the advertisement requester, the advertising agent substitute and the advertising mediator to input respective identification IDs and passwords; and a function to determine whether or not an input or output of information is permitted based on the identification IDs and passwords so inputted.

9. An advertising media information mediating system as set forth in claim 7, comprising: a function to encourage the advertisement requester, the advertising agent substitute and the advertising mediator to input respective identification IDs and passwords; and a function to determine whether or not an input or output of information is permitted based on the identification IDs and passwords so inputted.

10. An advertising media information mediating system as set forth in claim 2, wherein the advertisement request conditions which are registered by the advertisement requester or the advertising mediator include advertising targets, the number of people who are desired to execute advertisement using an advertisement material, a period of time, an area, a target, an advertising budget, date and time, an advertisement posting space and an advertising target material to which advertisement is applied, and wherein the advertising service substitution conditions which are registered by the advertising agent substitute include whether or not the advertising agent substitute wears or uses the advertising material for advertisement, the number of people who can execute advertisement using the advertisement material, a period of time, a place, date and time, whether or not an advertisement posting space and a target material to which advertisement can be applied can be secured, and furthermore, information on whether of not posters are posted, whether or not pamphlets, catalogues, leaflets and flyers are placed, whether or not a sampling (distribution of test products) is carried out, whether or not a visual image is broadcast, whether or not pieces of music are broadcast, whether or not announcements are made for notification and description, whether or not campaign products are sold, whether or not products are displayed for reservations, whether or not a place (in front of a shop, part of the interior of the shop or parking lot of the shop) is provided, and whether or not a cooperation is provided to hold an event.

11. An advertising media information mediating system as set forth in claim 7, wherein the advertisement request conditions which are registered by the advertisement requester or the advertising mediator include advertising targets, the number of people who are desired to execute advertisement using an advertisement material, a period of time, an area, a target, an advertising budget, date and time, an advertisement posting space and an advertising target material to which advertisement is applied, and wherein the advertising service substitution conditions which are registered by the advertising agent substitute include whether or not the advertising agent substitute wears or uses the advertising material for advertisement, the number of people who can execute advertisement using the advertisement material, a period of time, a place, date and time, whether or not an advertisement posting space and a target material to which advertisement can be applied can be secured, and furthermore, information on whether of not posters are posted, whether or not pamphlets, catalogues, leaflets and flyers are placed, whether or not a sampling (distribution of test products) is carried out, whether or not a visual image is broadcast, whether or not pieces of music are broadcast, whether or not announcements are made for notification and description, whether or not campaign products are sold, whether or not products are displayed for reservations, whether or not a place (in front of a shop, part of the interior of the shop or parking lot of the shop) is provided, and whether or not a cooperation is provided to hold an event.

12. An advertising media information mediating system as set forth in claim 2, wherein in the event that the advertising agent substitute provides a shop and facility, the advertising substitution conditions include information on the types and forms of the shop and facility which constitute shop and facility data, age levels of people who use and visit the shop and facility, a male and female ratio of the people, annual and monthly numbers of the people who use and visit the shop and facility and an average staying time, whereas the advertisement requester can retrieve the information from the wide conditions including age levels of people who use and visit the shop and facility, a male and female ratio of the people, and the types and forms of the shop and facility through a simple operation, and can select in a pin-point fashion the shop and facility which are used by advertising targets, whereby the advertising agent substitute can be selected.

13. An advertising media information mediating system as set forth in claim 7, wherein in the event that the advertising agent substitute provides a shop and facility, the advertising substitution conditions include information on the types and forms of the shop and facility which constitute shop and facility data, age levels of people who use and visit the shop and facility, a male and female ratio of the people, annual and monthly numbers of the people who use and visit the shop and facility and an average staying time, whereas the advertisement requester can retrieve the information from the wide conditions including age levels of people who use and visit the shop and facility, a male and female ratio of the-people, and the types and forms of the shop and facility through a simple operation, and can select in a pin-point fashion the shop and facility which are used by advertising targets, whereby the advertising agent substitute can be selected.

14. An advertising media information mediating system as set forth in claim 2, wherein in the event that the advertising agent substitute is a sports team, information on playing schedule, the number of people who are expected to visit a playing field, whether or not a TV broadcast is planned, whether or not an interview of players is planned, and whether or not exposure via posters is planned is registered as the advertising service substitution conditions, whereby the advertisement requester can retrieve the playing schedule or match schedule of the advertising agent substitute who executes an advertisement using the advertising material through a simple operation and can make a request for an advertising that is to be made on behalf thereof in consideration of the exposure schedule of the advertising material.

15. An advertising media information mediating system as set forth in claim 7, wherein in the event that the advertising agent substitute is a sports team, information on playing schedule, the number of people who are expected to visit a playing field, whether or not a TV broadcast is planned, whether or not an interview of players is planned, and whether or not exposure via posters and/or newspapers is planned is registered as the advertising service substitution conditions, whereby the advertisement requester can retrieve the playing schedule or match schedule of the advertising agent substitute who executes an advertisement using the advertising material through a simple operation and can make a request for an advertising that is to be made on behalf thereof in consideration of the exposure schedule of the advertising material.

16. An advertising media information mediating system as set forth in claim 2, wherein in the event that the advertising agent substitute is a model, musician, artist, talent, public entertainer, and famous person, information the number of people who are expected to visit a concert, talk show, event, stage, fashion show or the like, whether or not a broadcast is scheduled over a TV network, whether or not interviews of players by magazines are planned, and whether or not exposures via newspapers and/or posters are scheduled is registered as the advertising service substitution conditions, whereby the advertisement requester can retrieve playing schedules of the advertising agent substitute who performs an advertisement on behalf of the advertisement requester using the advertising material through a simple operation and can place with the advertising agent substitute a request for performing an advertisement on behalf of the advertisement requester in consideration of the exposure schedule of the advertising material.

17. An advertising media information mediating system as set forth in claim 7, wherein in the event that the advertising agent substitute is a model, musician, artist, talent, public entertainer, and famous person, information the number of people who are expected to visit a concert, talk show, event, stage, fashion show or the like, whether or not a broadcast is scheduled over a TV network, whether or not interviews of players by magazines are planned, and whether or not exposures via newspapers and/or posters are scheduled is registered as the advertising service substitution conditions, whereby the advertisement requester can retrieve playing schedules of the advertising agent substitute who performs an advertisement on behalf of the advertisement requester using the advertising material through a simple operation and can place with the advertising agent substitute a request for performing an advertisement on behalf of the advertisement requester in consideration of the exposure schedule of the advertising material.

18. An advertising media information mediating system as set forth in claim 2, wherein the advertisement request conditions which are registered by the advertisement requester or the advertising mediator include at least, as the characteristics of advertising request information, advertisement request conditions such as image data or visual data of the external appearance of an advertising product, and the type of business of the advertisement requester described by character data or numerical data, the name of a product, an advertising period, an advertising target, a desired advertising area and an advertising budget.

19. An advertising media information mediating system as set forth in claim 7, wherein the advertisement request conditions which are registered by the advertisement requester or the advertising mediator include at least, as the characteristics of advertising request information, advertisement request conditions such as image data or visual data of the external appearance of an advertising product, and the type of business of the advertisement requester described by character data or numerical data, the name of a product, an advertising period, an advertising target, a desired advertising area and an advertising budget.

20. An advertising media information mediating system as set forth in claim 2, wherein the advertising mediator is provided with a function to mediate an advertisement requester and an advertising agent substitute which are stored on the advertising media information mediating server so as to negotiate and proceed with a required transaction for agreement.
